(19) United States
(12) Patent Application Publication
(10) Pub. No.: US 2008/0147354 A1
(43) Pub. Date: Jun. 19, 2008

(54) System and method for participation in a cross platform and cross computerizied-eco-system rating service

(76) Inventors: Michael J. Rowan, Wakefield, MA (US); Christopher T.M. Bailey, Atlanta, GA (US); Kefeng Chen, Duluth, GA (US); Neal Lewis Creighton, Wellesley Hills, MA (US)

Correspondence Address: WILMERHALE/BOSTON, 60 STATE STREET, BOSTON, MA, 02109, US

(21) Appl. No.: 11/711,223

(22) Filed: Feb. 27, 2007

Related U.S. Application Data
(63) Continuation-in-part of application No. 11/639,679, filed on Dec. 15, 2006.
Application No. 11/639,679 is a continuation-in-part of application No. 11/639,678, filed on Dec. 15, 2006.

(51) Int. Cl. G06F 17/40

(52) U.S. Cl. 702/182

(57) ABSTRACT

A system and method for participation in a cross platform and cross computerized-eco-system rating service. A computerized rating service identifies a plurality of users of the computerized rating service. Each user may interact with a computerized entity via a user display and computerized user controls associated with that display. Ratable computerized entities are accessible by way of the user display and computerized user controls. Computerized rating controls are provided to be co-presented on the user display with the ratable computerized entity. The rating controls allow each user to submit computerized rating information about the ratable entity without substantially disrupting said user's observation of and interaction with the ratable computerized entity.

### CROSS-REFERENCE TO RELATED APPLICATION

This application is a continuation-in-part of and claims priority under 35 U.S.C. §120 to U.S. patent application Ser. No. 11/639679, filed on Dec. 15, 2006, entitled SYSTEM AND METHOD FOR PARTICIPATION IN A CROSS PLATFORM AND CROSS COMPUTERIZED-ECO-SYSTEM RATING SERVICE, the contents of which is incorporated herein in its entirety by reference.

This application is also a continuation in part of and claims priority under U.S.C. §120 to U.S. patent application Ser. No. 11/639678, filed on Dec. 15, 2006, entitled SYSTEM AND METHOD FOR DETERMINING BEHAVIORAL SIMILARITY BETWEEN USERS AND USER DATA TO IDENTIFY GROUPS TO SHARE USER IMPRESSIONS OF RATABLE OBJECTS, the contents of which is incorporated herein in its entirety by reference.

This application is also related to U.S. patent application No. TBA, filed on date even herewith entitled SYSTEM AND METHOD FOR MULTIPLAYER COMPUTERIZED GAME ENVIRONMENT WITH NON-INTRUSIVE CO-PRESENTED COMPUTERIZED RATINGS, the contents of which is incorporated herein in its entirety by reference.

### BACKGROUND

1. Technical Field of the Invention

The present invention relates generally to electronic services that allow users to rate services and the like and to receive rating information about such services and the like and, more particularly, to a system and method for participation in a cross platform and cross computerized-eco-system rating that allows users to non-disruptively rate services while using and viewing such entities.

2. Discussion of Related Art

It is helpful for individuals or entities (users of the service) to have rating information and feedback, and to know as much information as possible before performing actions such as interacting with a web site, purchasing a product, reading a news article, or depending on a review etc.

Typically rating systems are self-contained and the information within them is not available in a portable fashion, i.e. outside its own portal/web site and/or service environment.

There are some services, e.g., stumbleupon and lijit, that provide a third-party feeback mechanism for a participant (i.e., independent of the service being used). Some systems include a form of group concept and group rating or group opinion.

### SUMMARY

The present invention provides a system and method for participation in a cross platform and cross computerized-eco-system rating service.

Under one aspect of the invention, method of providing a computerized rating service is provided. The method comprises identifying a plurality of users of the computerized rating service, wherein each of said plurality of users interacts with a computerized entity via a user display and computerized user controls associated with that display. Additionally, a plurality of ratable, identifiable computerized entities are identified wherein each of said plurality of ratable identifiable computerized entities is accessible to at least one of said plurality of users by way of said user display and computerized user controls. Computerized rating controls to be co-presented on the user display with the ratable, identifiable computerized entity, said rating controls allowing each user to submit computerized rating information about the ratable entity substantially allowing the user continuous, uninterrupted observation of and interaction with said ratable, identifiable computerized entity are provided. The method also comprises providing computerized rating information to be co-presented on the user display with the ratable, identifiable computerized entity, where the computerized rating information including an aggregate rating that is a function of a set of users of the computerized rating service. The rating information is collected by a service that is separate from the ratable, identifiable computerized entities and wherein said collected information is processed to create the aggregate rating by a service that is separate from the ratable computerized entities.

Under another aspect of the invention, different aggregate ratings are provided depending on whether a user is a registered user of the service or an unregistered user of the service.

Under another aspect of the invention, the aggregate rating is a mean rating from a set of users of the service.

Under another aspect of the invention, the aggregate rating is a mean rating from a defined set of users associated with a given user by similar activity among users in the set.

Under another aspect of the invention, the ratable, identifiable computerized entities are identified by at least one of a unique user identification (UUID), Asset ID and Object ID.

Under another aspect of the invention, the ratable, identifiable computerized entities are identified by an identification including assets, agents and simulators.

Another aspect of the invention provides the computerized rating information to the computerized rating controls to be co-presented on the user display with the rating controls.

Under another aspect of the invention, the computerized rating controls includes a private panel available to a registered user including controls to submit rating information and areas for displaying rating information.

Under another aspect of the invention, the computerized rating controls include an overlay to be co-presented on a browser for co-presenting the ratable service, said overlay including controls to submit rating information and areas for displaying rating information

Under another aspect of the invention, the plurality of ratable identifiable computerized entities are entities of the gaming environment further comprising a multiplayer gaming environment and wherein the plurality of users of the computerized rating service are users of the gaming environment.

Under another aspect of the invention, the computerized rating information is selectively displayed in accordance with the user's proximity within the gaming environment to a ratable identifiable computerized entity.

Under another aspect of the invention, the rating control includes an overlay to be co-presented on a gaming environment display, said overlay including controls to submit rating information and areas for displaying rating information.

Under another aspect of the invention, the computerized rating information is co-presented in fixed space relation, as determined within the gaming environment, to the ratable identifiable computerized entity.

Under another aspect of the invention, the ratable identifiable computerized entity includes registered and unregistered users of the service.

Under another aspect of the invention, rating information collected by a service that is separate from the ratable computerized entity includes rating information on a plurality of ratable identifiable computerized entities that are entities of a gaming environment and rating information on a plurality of ratable identifiable computerized entities that are not entities of the gaming environment.

### BRIEF DESCRIPTION OF THE DRAWINGS

In the drawing:

FIG. 1 illustrates a system architecture that allows participates to collaborate rating information about resources, according to certain embodiments of the invention;

FIG. 2 illustrates an example of a toolbar that allows the participant to interact with the rating service environment;

FIG. 3 illustrates an example of the process flow for rating request and delivery and the interaction between the toolbar and the rating service environment;

FIG. 4 illustrates an example process flow of the rating function provided on the toolbar, and the interaction between the toolbar and the rating service environment;

FIG. 5 illustrates an example process flow of the “my rating” function provided on the toolbar, and shows the overall interaction between the toolbar and the rating service environment;

FIG. 6 illustrates an example of the GABlet container (in minimized state), which is an overlay technology;

FIG. 7 illustrates an example of the GABlet container (in its expanded or maximized state), an overlay technology, when the user is in a non-authenticated state;

FIG. 8 illustrates an example of the GABlet container (in its expanded or maximized state), an overlay technology, when the user is in an authenticated state;

FIG. 9 illustrates an example process flow of the GABlet (an overlay technology) request and delivery process and the interaction that occurs when the toolbar in combination with the GABlet container, or the GABlet container alone, is linked to an object and/or element within a page and how this works in conjunction with the rating service environment;

FIG. 10 illustrates an example of the how the rating service could be represented when a participant visits and interacts with a supported eco-system;

FIG. 11 illustrates an example of the how the rating service could be represented when a participant visits and interacts with a supported eco-system;

FIG. 12 illustrates an example of the how the rating service could be represented when a participant visits and interacts with a supported eco-system;

FIG. 13 illustrates an example of the how the rating service could be represented when a participant visits and interacts with a supported eco-system;

FIG. 14 illustrates an example of the how the rating service could be represented when a participant visits and interacts with a supported eco-system;

FIG. 15 is an example of a merchant participant, and in this particular case incorporating a rating badge by utilizing the API service; and

FIG. 16 is an example of a participant, utilizing a mail application and in this particular case incorporating a rating badge by utilizing the API service.

FIG. 17 is an example of the how the rating service could be represented when a participant visits and interacts with a eco-system supported by the rating service, Second Life which is an online game that allows people to participate in a virtual life game.

FIG. 18 illustrates an example process flow of the Community Badge View and the request and delivery process while a user or observer of the environment is exploring and encountering other people objects, and elements within the environment.

FIG. 19 illustrates an example process flow of the Community Badge View and the process that occurs when a user or observer of the environment is attempting to rate or GAB about a participant.

FIG. 20 illustrates an example process flow of the Community Badge View and the process that occurs when a user or observer of the environment is attempting to review GABs about a participant.

FIG. 21 illustrates an example process flow of the Community Badge View and the process that occurs when a user or observer of the environment is attempting to review more about a participant.

FIG. 22 illustrates an example process flow of the Private Camera View and the request and delivery process while a participant of the environment is exploring and encountering other people objects, and elements within the environment.

FIG. 23 illustrates an example process flow of the Private Camera View and the process that occurs when a participant of the environment elects to rate on a particular user, observer, people, objects or other elements in the environment.

FIG. 24 illustrates an example process flow of the Private Camera View and the process that occurs when a participant of the environment elects to gab on a particular user, observer, people, objects or other elements in the environment.

FIG. 25 illustrates an example process flow of the Private Camera View and the process that occurs when a participant of the environment elects to review the gabs on a particular user, observer, people, objects or other elements in the environment.

FIG. 26 illustrates an example process flow of the Private Camera View and the process that occurs when a participant of the environment elects to see more on a particular user, observer, people, objects or other elements in the environment.

### DETAILED DESCRIPTION

Preferred embodiments of the invention provide a cross platform and cross computerized-eco-system rating service. Preferred embodiments collect, maintain, and manage rating information regarding items such as universal resource indicators (URIs), computer applications, web sites, web pages, components of web pages such as a product listing or news article, user ids and other entities that are identifiable or selectable by users and by the context of use. User-side application components, such as toolbars or overlays, facilitate interaction with, and delivery of, the rating materials to the user so that the user can generate and receive rating information without substantially disrupting their interaction with the website, URI or other ratable entity. For example, mechanisms are provided to send or receive rating information in a manner that allows the user to continue to view and interact with a webpage or the like, and that does not require the user to visit another webpage or open another browser, etc.

Preferred embodiments provide a mechanism for portable rating information that is accessible, for example, when a user lands on a particular web page, or observes an item on an electronic storefront. Direct access to an overall rating, based on community and general input (with options to have this tailored to the likes and dislikes of the user) is made available. In addition, a user of the service has direct access to his/her specific rating information and profile for a particular item and also direct and convenient access to community and general users whose likes and dislikes are similar or not.

Under certain embodiments, a rating service allows a user to take advantage of, access, and participate in ratings across multiple platforms and eco-systems, allowing the rating information to be delivered to the user when they need it and in the environment they need it in. As an example, as a user is traversing the web and landing on different sites, and different pages within those sites, the rating information will be delivered directly to them for concurrent use. In a particular eco-system (e.g., eBay) preferred embodiments of the invention know that a user is in a supported eco-system, thus allowing the service and tools to interact with this eco-system. This will allow the user to see and participate with the rating information as appropriate, directly within the eco-system, without the need to leave and visit a portal site. For example, a user of the service may be visiting a supported eco-system, and within this eco-system the service supports ratings tagged or associated to the ecosystem's user identifiers (ids). When a user of the service encounters an ecosystem user id the appropriate rating information will be associated with this user id directly and delivered in a web overlay type mechanism which makes the information appear as it is embedded and/or attached to the eBay user id. This information can also be made available and displayed within a client tool such as a toolbar. Through this they will have direct access to see rating information that is housed outside of the eco-system and managed by the users participating in the service.

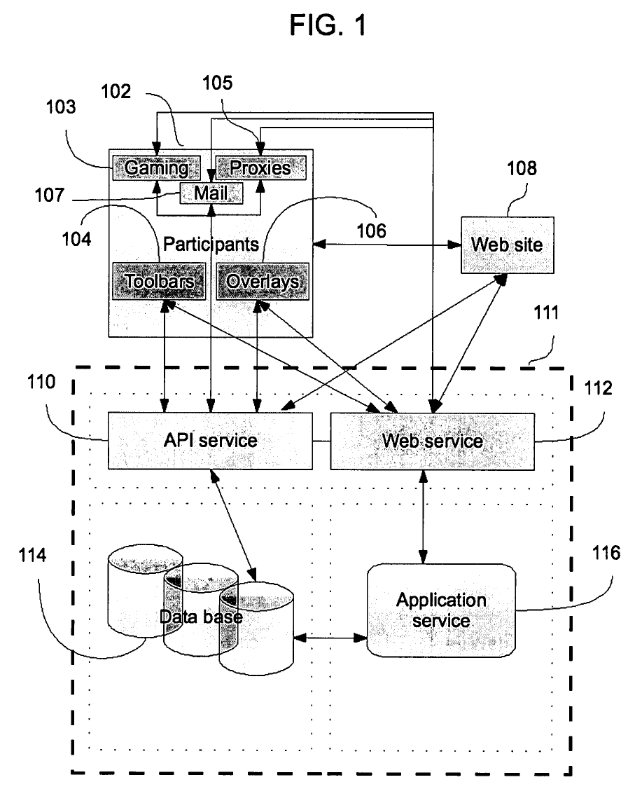

FIG. 1 illustrates a system and/or combined service 111 that allows participants to provide, receive and utilize rating information about a particular URI and/or application or an element and/or object within or accessible via a URI and/or application in a portable fashion across multiple platforms and eco-systems. The service 111 is built using traditional server hardware, software and common networking components which can be housed and operated in a single location, or be housed and operated in a distributed fashion. There are several individual components that when working together make a full and robust rating service 111 environment. Specifically, the there are two main elements, or components needed, a service 111 environment which would accept, process and make available rating information, and participants 102 which would consist of registered and non-registered users of the service 111.

The service 111 itself encompasses many individual components all which when working together can accept, process and make available rating information. Some of the products and utilities utilized are or could use standard off the shelf products, while others may need to be and are custom development projects. In reviewing the details and components of the service 111 environment there are several main components to discuss.

First and foremost the service 111 has a Web service 112 which is made up of a traditional HTTP server, in this case Apache and mongrel (a fast, small lightweight HTTP server for RoR [Ruby on Rails]) which enables processing of standards based HTTP and other requests from participants 102, items used by participants 102 such as, overlays 106, toolbars 102, mail 107, gaming 103, and proxy 105 applications and allows the requests to be handed off and processed by an application service if needed, such as in the case of the service 111, some requests are handled by the Application service 116.

Next, the service 111 makes use of an Application service 116, which works in conjunction with the Web service 112 and can be developed using any standard licensed or open source, or similar application server technology. In the case of the service 111 the Application service 116 is developed to leverage and use the RoR (Ruby on Rails) platform, which consists of the Ruby language which is a dynamic, open source programming language that focuses on simplicity and productivity. It has an elegant syntax that is designed to be natural to read and easy to write. Ruby was developed by blending parts of the following languages (Perl, Smalltalk, Eiffel, Ada, and Lisp) and, Rails which is a full-stack framework for developing database-backend web applications according to the Model-View-Control pattern. The Application service 116 has constant communications with the Web service 112, and performs the processing from any Web service 112 that require storage to and access from the database 114.

Database 114 consists of a standard ODBC compliant database architecture and is built using industry standard MySQL database. The database is used to store basic registration data, ratings and rating comments, participant 102 specific settings, and other maintenance information. Under certain embodiments detailed social calculations, and algorithm processes are off loaded and/or work in conjunction with the API service 110, as is disclosed in co-pending application “System and method for determining behavioral similarity between users and user data to identify groups to share user impressions of ratable objects”. However, other forms of rating techniques may be employed in connection with preferred embodiments of this invention.

The final main component in the service 111 environment is the API service 110, which is used to process and handle toolbar 104, overlay 106 and other tools used by the service participants 102 that require specific socialized calculations and in very fast response times. The API service 110 is used to handle participant 102 requests, which traditionally consists of individual users, but may also consist of entities. Specifically web sites 108 may actually call and interact with the API service 110 as well as the Web service 112 if they wish to participate and present rating related materials from the service 111 within their web site 108 environment and pages. (See co-pending application “System and Method for Determining Behavioral Similarity Between Users and User Data to Identify Groups to Share User Impressions of Ratable Objects.”)

The other important aspect of the service 111 are the participants 102 which can utilize standard Internet applications such as browsers like Microsoft Internet Explorer, Firefox, Flock, Safari, Opera and others as well as common mail programs such as Microsoft Outlook, Microsoft Outlook Express, Eudora, Thunderbird, Lotus Notes and others. In addition participants 102 can utilize gaming, and proxy related applications which interact with the service 111 for rating related information and processes. Overall, there are many different types of applications, tools and utilities that participants 102 can use to interact with the service 111.

Toolbars 104 are a common component that can be used to interact with and participate with a computerized service. In the case of the service toolbars 104 they are built for multiple platforms, such as Microsoft Internet Explorer and Mozilla Firefox, and also for common email programs such as Microsoft Outlook, Microsoft Outlook Express. In addition, the web browser based toolbars 104 mentioned above aid as a mail application toolbar 104 when servicing web-based email. The toolbars 104 are built utilizing standard off the shelf toolbar builder applications that allow a developer to build a base line toolbar, add buttons, selection options and triggers for interaction with a service or application. In the case of the service 111 toolbars 104, they are built with basic button and selection options, and focus on calling initiating, calling and working with scripts and the Web service 112 and API service 110 when a participant 102 utilizing a service 111 toolbar 104 moves from site to site, and page to page. After each page loads, the toolbar triggers a script to be injected into the page which calls supporting scripts, objects or elements such as flash which aid and support the overlay which will be discussed shortly in this document. In addition the page the user is visiting and content from the page if needed can be sent to the Web service 112 and/or API Service for processing and response of rating related information.

Overlays 106 are a common way for developers to execute some script on a web page allowing an affect to be presented to a user viewing a page, such as a mouse over process that when invoked would make a bubble window appear to be hovering over the content within the page, and subsequently render some arbitrary information in the bubble. The overlay 106 that is provided by the service 111 is a similar concept, but the script to be used to show the rating information does not have to be embedded on the web site 108 page a user is viewing, rather the service 111 toolbar injects an action to start the script loading process based on a trigger, for instance when a participant 102 of the service moves form page to page. The overlays 106 interface with the service 111 API service 110 and Web Service 112.

In addition to the components discussed above, participants 102 can use the service 111 while participating in gaming 103 activities, where the participant 102 would be able to access, provide into and interface with the service 111 while in the game 103 and make use of rating information. Also, proxy 105 related applications can use the service 111 such that as traffic or information pass through the proxy application rating related information could deter the outcome of the process if it were configured to do so. In addition, the participant 102 using the proxy application could access, provide to, and interface with the service 111.

Lastly, mail 107 applications are able to have a similar toolbar as described above, allowing participant 102 convenient access to rating related controls allowing participation in the service 111. Mail messages received (if configured) are tagged with a rating badge which show the necessary rating information pertaining to the email, such as the URL, URI, email address or addresses in the email as well as the email content itself.

Making use of some of these common Internet applications, an extension or add-on known as a toolbar 104 as well as an overlay 106 can be utilized or a module, script or plug-in can be provided for the gaming, and proxy related applications which allows interactions such as requests for rating information to be sent and received from the API service 110 and Web service 112. Depending on the rating needs some of the applications such as the browser toolbars will be active while traversing the web and visiting individual web sites 108 and pages and reviewing objects and/or elements within these pages. These requests are received by both the API service 110 and the Web service 112 and sent to each according to the nature of the details needed by the toolbar 104. The requests that are sent to the API service 110 will typically be handled by the API service 110 itself, and in some cases the API service 110 will communicate with the Web service 112 and often perform data base 114 transactions as needed. Just as requests from the toolbar are received form the API service 110, certain requests are also sent directly to the Web service 112 as well. In the case where the Web service receives a request the Web service often utilizes the Application service 116 as well as the database 114 to retrieve and store information pertaining to the requests. In addition, the Web service 112 and Application service 116 combined will send requests to the API service as needed to obtain cached related results and specific information related to social status information such as a arithmetic mean response or arithmetic social circle mean response.

For example, when the participant 102 visits a new web site 108 utilizing the toolbar 104 which is enabled within their browser environment, there may be one or more requests send to the service 111. One request, which includes the initial rating request for the current visited web site 108 will be sent directly to the API service 110, which in turn will respond with a proper response in a format that the toolbar 104 can interpret and represent to the participant 104 in a graphical manner. In addition the toolbar 104 will initiate a script or object, injecting this into the rendering area of the browser window which in turn will call supporting scripts and objects such as JavaScript, flash or other common scripts and embedded technologies from the Web service 112 and Application service 116 combined as needed. This will result in an overlay 106, which appears initially in its minimized state in the rendering window of the browser being used by the participant 102. This overlay 106 allows the participant 102 to have access to rating information pertaining to the web site 108 or objects and/or elements within the web site 108 the participant 104 is viewing by simply utilizing the overlay 106 and making this expand form its minimized state to its maximized state.

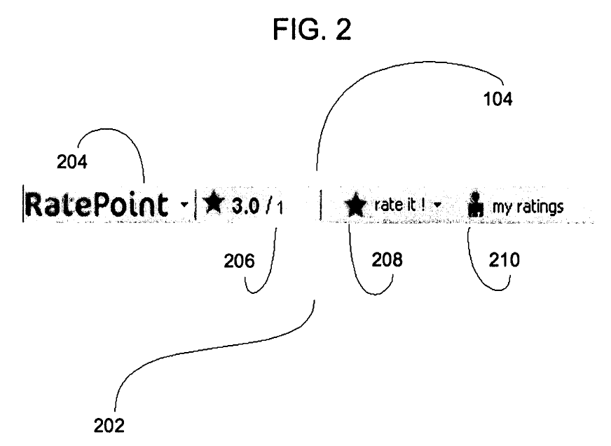

FIG. 2 is an example of a toolbar 104 that can be utilized by a participant 102 in the rating service 111. The toolbar 104 may be installed as part of a common browser environment and allows the participant to interact with the rating service environment. This toolbar 104 has four main components that consist of the following: a menu structure 204 that allows convenient access to basic toolbar 104 functions, such as on/off settings; show/hide settings; and access to help and other relevant information about the rating service 111. In addition, the rating display 206, which is updated to display the relevant rating information based on the web site 108, the participant 102 is visiting. In addition to this being displayed, the participant 102 has the ability to click this section and access the details about the web site 108 at the rating service 111. The rating display 206 is updated and changes each time a participant 102 visits a new web site 108 or page within a web side 108. As the participant 102 utilizing a service toolbar 104 moves from site to site, and page to page a request is sent to the API service 110 with details about the web site 108 the participant 102 is visiting. With this information the API service 110 can present rating information back to the toolbar 104 for presentation to the participant 102. This is done each time a participant 101 visits a new web site 108 or page within a web site 108. Or, if the participant 102 elects to obtain rating information on a particular selectable, identifiable item or element that is accessible. Also, there is the rate it! 208 button, allowing the participant 102 the capability to provide real-time rating feedback about the web site 108. When used, basic site details such as the web site 108 URL/URI and title are sent to the rating service 111, and presented to the participant 102 in a form like fashion which allows the participant 102 to add additional details such as a rating, description, tags and GABs or comments before submitting the rating to the service 111. Lastly, the my ratings 210 button enables the participant 102 to visit the rating service 111 in an authentication fashion. If this option is used, and the participant 102 is not authenticated, the service 111 provides the ability for authentication. Once authentication information is provided and validated the participant 102 has access to a personalized version of the rating service 111, allowing the participant 102 to view a history of ratings, interact with the service 111 by supplying ratings, GABs or comments and other service 111 features.

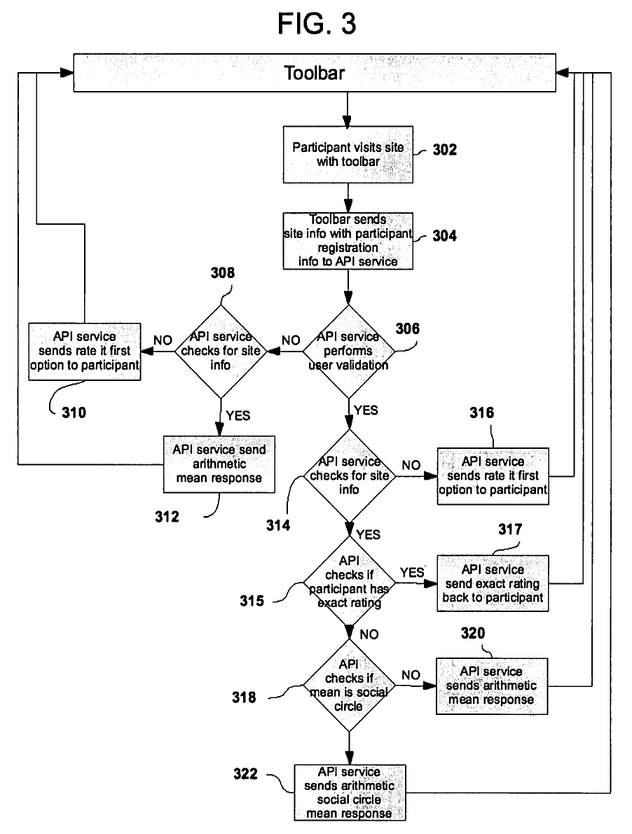

FIG. 3 is a an example of the process flow of the rating request and delivery process while a user is traversing the web and visiting sites, pages, and reviewing content and objects and/or elements within the pages. It shows the overall interaction that occurs when the toolbar works in conjunction with the rating service environment.

The diagram outlines the process flow in which a toolbar 104 interacts with the API service 110 portion of the service 111. In this example a service 111 participant 102 is provided the rating information about a particular web site 108 by the toolbar 104 communicating with the API service 110 to obtain real-time rating information from the service 111 community as well as the ability to access detailed rating information and comments and notes left by other participants 102 in the service 111. This is done each time a participant 101 visits a new web site 108 or page within a web site 108. Or, if the participant 102 elects to obtain rating information on a particular selectable, identifiable item or element that is accessible. At step 302 the participant is using a traditional web browser and visiting a new web site 108 page. At step 304 when the participant 102 visits the new web site 108 page the toolbar 104 automatically sends the related web site 108 information such as, URL/URI to the API service 110 so the API service 110 may in turn provide the most accurate rating information back to the participant 102 via the toolbar 104 and display this information in the rating output 206 section. In this particular case, the participant 102 has elected to have the toolbar 104 in automatic mode, which allows a rating request to be sent to the API service 110 automatically upon page traversal which options can be configured in the rating menu 204 section. The participant 102 also has the ability to disable this feature and obtain rating information about the web site 108 page upon manual request. At step 306 the API service 110 receives the rating request from the participants 102 toolbar 104 and first performs basic validation processes to determine if this is a registered participant 102. Specifically, the APi service 110 will evaluate if this toolbar 104 has been utilized within the service 111 before and if so determine which participant 102 it is registered too. If the API service 110 determines that the requests is not registered step 308 will check to see if there is any rating information about the web site 108 page in the service 111 environment. In the case there is specific information about this web site 108 page, at step 312 the service 111 will return an arithmetic mean response (and arithmetic mean response is a general rating response that has no social correlation to the participant and display this in the rating output 206 section of the toolbar 104). If it is determined the service 111 does not have any specific information about this web site 108 page in the service 111 environment, at step 310 a response is provided to the participant 102 and displayed in the rating output 206 section of the toolbar 104 which allows the option/capability for the participant 102 to be first in providing rating information for this web site 108 page to the Web service 112.

If in step 306 it is determined that the participant 102 is registered, then at step 314 the service 111 will check to see if there is any rating information about the web site 108 page in the service 111 environment. If rating information is not found then at step 316 the API service 110 will provide a response to the participant 102, which is displayed in the rating output 206 section of the toolbar 104, this allows the participant 102 the option/capability to be first in providing rating information for this web site 108 page to the Web service 112. If during step 314 rating information is found the service 111 then step 315 evaluates the information found to determine if the participant 102 has and exact rating. If it is found that the participant 102 does have an exact rating then this exact rating information is sent back to the participant 102 as described in step 317 and displayed in the rating output 206 section of the toolbar 104. If in step 314 it is determined that the service 111 does not have an exact rating for the participant 102 then at step 318 the API service 110 evaluates the information found to determine if there is enough information to provide an arithmetic social circle mean response (which is a response that has a social correlation to the participant 102), see, e.g., incorporated patent application, identified above. If there is no arithmetic social circle mean response information, the API service 110 will then return the arithmetic mean response as described in step 320 and display this in the rating output 206 section of the toolbar 104. If there is enough information in the service 111 to provide an arithmetic social circle mean response at step 322 this will be sent to the participant 102 and made available for display in the rating output 206 section of the toolbar 104.

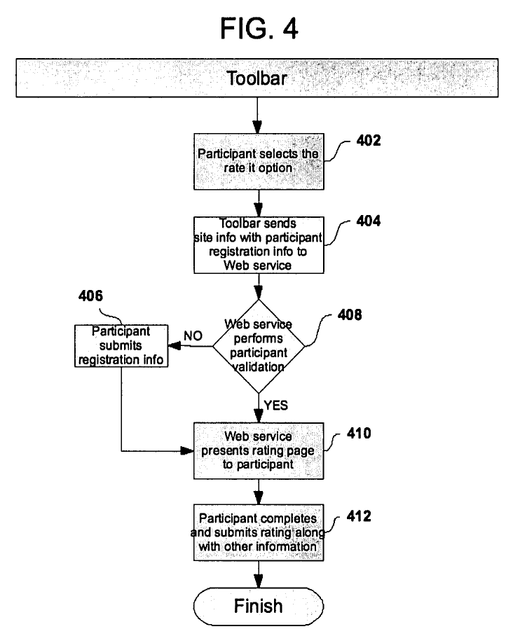

FIG. 4 illustrates an example process flow of the rating function provided on the toolbar, which allows the user convenient abilities to rate a site, page, and objects and/or elements of a page they are visiting. It shows the overall interaction that occurs when the toolbar works in conjunction with the rating service environment.

The diagram outlines the process flow in which a participant 102 selects the rate it option 208 available on the toolbar 104. In step 402 when a participant 102 visits a new web site 108 page the participant 102 selects the rate it 208 option on the toolbar 104. When selected, and as outlined in step 404 the toolbar sends selected web site 108 page information to the Web service 112. In step 408 the Web service 112 receives this web site 108 page information and performs basic participant 102 checks to determine if the participant is registered with the service 111. If the participant 102 is not logged in to the service 111 in step 406 the Web service 112 prompts the participant 102 to enter login details. When the participant 102 has been validated by the service 111 in step 410 the Web service 112 displays and presents a rating collection page. The rating collection page captures information from the original rate it 206 request sent from the toolbar 104 and makes some of this information available in a form like fashion to the participant 102. In step 412 items such as the web site 108 page URL/URI, and web site 108 page title are presented and able to be modified by the participant 102 in the presented form. In addition, the participant 102 can provide a rating, comments, and tags along with the submission, as well as determine if this submission should be public, private or shared amongst a specific group of participants 104 or participant 104 groups. Upon completing the rating request the participant submits the rating.

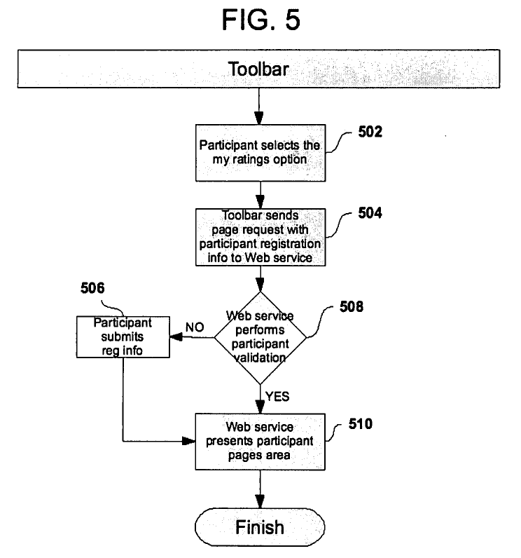

FIG. 5 is an example process flow of the “my rating” function provided on the toolbar, which allows the user convenient access to visit their personal profile pages as well as have authenticated access within the rating service environment. It shows the overall interaction that occurs when the toolbar works in conjunction with the rating service environment.

The diagram outlines the process flow in which a participant 102 selects the my ratings 210 option available on the toolbar 104. In step 502 when a participant 102 selects the my ratings 208 option, the toolbar 104 in step 504 sends a request to the Web service 112 which requests admittance to an authenticated area on the service 111 web service 112. In step 508 the Web service 112 receives the request and determines if the participant 102 is validated. As outlined in step 506 if the participant 102 is not validated the Web service 112 prompts the participant 102 to enter login details for access to the requested area of the Web service 112. If in step 508 the participant 102 is validated with the Web service 112 then in step 510 the authenticated area and capabilities of the Web service 112 are made available to the participant 102.

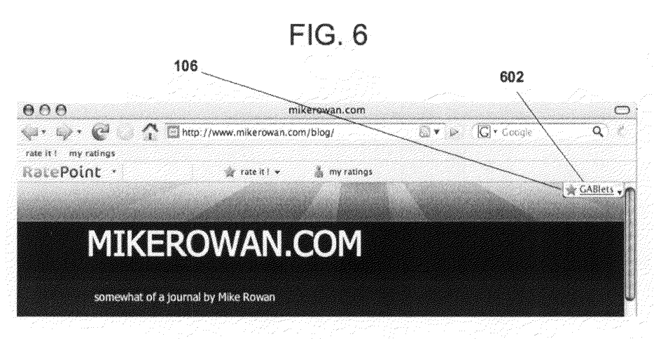

FIG. 6 illustrates an example of the GABlet container (in its GABtab and minimized state), which is an overlay technology. This feature is presented as the participant moves from site to site, page to page, and will give the user access to more details about the site, page and objects and/or elements within the pages. It shows the overall interaction that occurs when the toolbar works in conjunction with the rating service environment.

The overlay 106 is made available to participants 102 while using the toolbar 102 and visiting web site 108 pages. This overlay 106 is initially displayed in its minimized state. This overlay within the service 111 environments and participant 102 tools is called a GABlet, which is defined as a container which can be portable or static and provide access to view and access rating, comment and additional information know to the service 111 in a whole. It is designed for portability so as participant 102 move from site to site and page to page, the GABlet container is made available within the browser area, reducing the need for the participant 102 to leave the intended page to review, and participate in rating transactions. In this example the participant 102 has elected to show the overlay 106 while traversing web site 108 pages. The overlay 106 is presented by the toolbar placing an initiating script or object in the rendering area of the browser in conjunction with the web page 108 as the participant 102 traverses. Upon the placement of this initiating script or object in the web site 108 page additional supporting scripts and objects such as JavaScript, flash or other common scripts and traditional embedded technologies will be inserted. The combination of the scripts being inserted allow an overlay 106 to be displayed within the web site 108 page shown in the browser rendering area. Depending on the information the service 111 has about a particular web site 108 page or elements and/or objects within the web site 108 page the overlay 106 can display different status information. For example, if the service 111 does not have any information about the web site 108 page or objects and/or elements within the web site 108 page the overlay 106 could display an option to instruct or ask the participant 102 to be the first to rate. In another example the overlay 106 could display the initial rating information known to the service 111, therefore allowing the participant 102 to see this rating information inline with the web site 108 page. If the participant 102 chooses, the overlay 106 may be selected to take it from its minimized state to and expanded state allowing an rating details know by the service 111 t be displayed and interacted with by the participant 102.

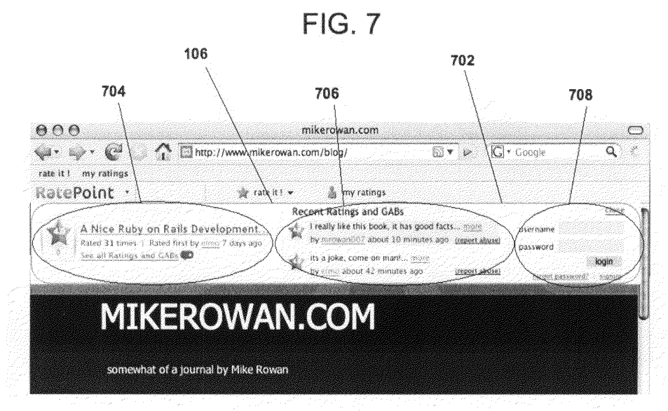

FIG. 7 illustrates an example of the GABlet container (in its expanded or maximized state), which is an overlay technology. This function is presented to the participant when they elect to click the GABtab, thus instructing the GABlet window to appear and present additional information available about the site, page or objects and/or elements in the page. In this particular instance it show the participant in a not authenticated state, thus the need to login, register etc in order to participate in the rating service. It shows the overall interaction that occurs when the toolbar works in conjunction with the rating service environment.

The overlay 106 is made available to participants 102 while using the toolbar 102 and visiting web site 108 pages. This overlay 106 is displayed in its maximized state which is enabled by the participant 102 selecting the overlay 106, thus sending a request to the service 111 for more rating information about this particular web site 108 page or objects and/or elements within the web site 108 page. In this example the participant 102 has elected to show the overlay 106 while traversing web site 108 pages. The overlay 106 is initially delivered to the browser rendering area as described in FIG. 6. When the overlay 106 is in its maximized state it presents the rating information from the service 111 directly to the participant 102 without the need for the participant 102 to visit the service 111 directly with the web browser or other application in use. As an example, traditional rating services would require their users to visit their service directly to search for information relating to a particular web site. With preferred embodiments of the invention the rating information is delivered to the participant 102 as needed and in real-time when visiting a web site 108 page.

When a participant 102 first elects to maximize the overlay 106 the service 111 checks to see of the participant 102 is authenticated. If the participant 102 is not authenticated the form section 708 of the overlay 106 displays an authentication option for the participant 102 to authenticate to the service 111. This is needed of the participant 102 would like to perform a rating function from within the overlay 106 versus the toolbar 104 itself. If the participant 102 chooses to authenticate the ability to interact with the service 111 and perform functions such as rating, commenting, reporting abuse and other function will be available.

In addition to the participant 102 having the ability to interact and perform functions such as rating, commenting, and reporting abuse. The participant 102 has immediate access to see any relevant rating information about the web site 108 page the overlay 106 is displayed on. This information is shown in 704 and 706, which show the main rating information, and any details such as individual ratings, comments and other things respectively.

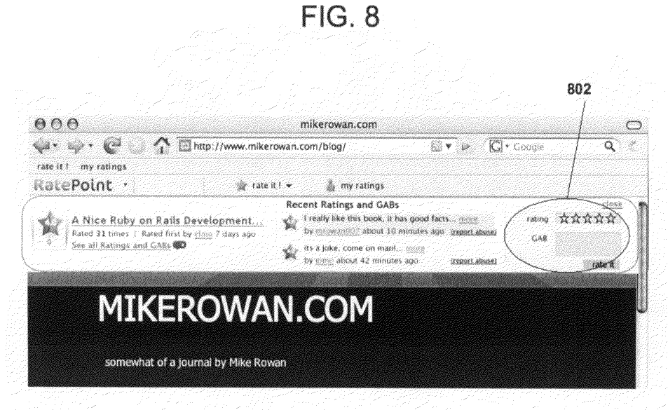

FIG. 8 illustrates an example of the GABlet container (in its expanded or maximized state), which is an overlay technology. This function is presented to the participant when they elect to click the GABtab, thus instructing the GABlet window to appear and present additional information available about the site, page or objects and/or elements in the page. In this particular instance it shows the participant in an authenticated state, thus allowing the participant to instantly participate in the rating service. It shows the overall interaction that occurs when the toolbar works in conjunction with the rating service environment.

The overlay 106 is made available to participants 102 while using the toolbar 102 and visiting web site 108 pages. This overlay 106 is displayed in its maximized state and as described in FIG. 7 the participant 102 has all the same viewing and interaction capabilities. In this particular example the form section 802 is in the mode, which allows the participant to supply a rating and comment details.

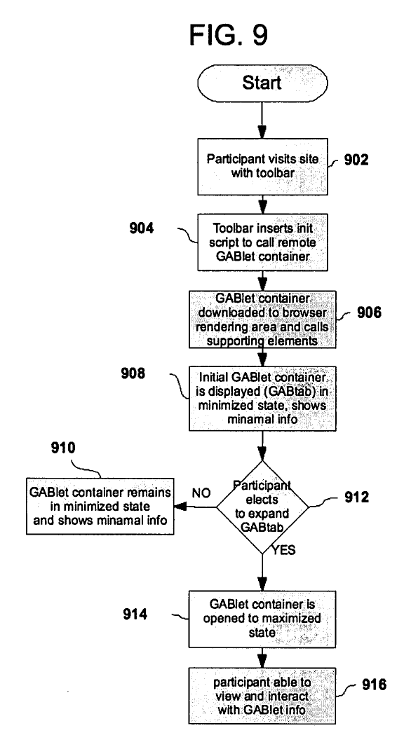

FIG. 9 illustrates an example process flow of the GABlet (an overlay technology) request and delivery process while a participant is traversing the web and visiting sites, pages, and reviewing content and objects and/or elements within the pages. It shows the overall interaction that occurs when the toolbar in combination with the GABlet container or with the GABlet container alone if installed on a page or site, or linked to an object and/or element within a page and how this works in conjunction with the rating service environment.

This process flow occurs when a participant 102 with a toolbar 104 visits a web site 108 and has the overlay 106 in a display or active mode. In step 902 the participant visits a web site 108 page as normal and as show in step 904 the toolbar inserts and initiates a script or object, injecting this into the rendering area of the browser and creates an initial container called a GABlet container. In step 906 the initial GABlet container now calls supporting scripts and objects such as JavaScript, flash or other common scripts and embedded technologies from the Web service 112 and Application service 116 combined as needed. Shown in step 908 this results in an overlay 106, which appears initially in its minimized state in the rendering window of the browser being used by the participant 102.

The participant 102 now has the ability to interact with the overlay 106 and request additional rating information from the service 111. In step 912 if the participant 102 chooses not to interact with the overlay 106 and view or participate with information about the web site 108 page or objects and/or elements in the web site 108 page through the overlay 106 it remains in its initial minimized state as shown in step 910. If at step 912 the participant 102 elects to view more rating information through the provided overlay 106 the overlay 106 is set to its maximized state and information is retrieved from the service 111 for display inside the overlay 106 rendering area. From here the participant 102 has the ability to review the rating and comment information as well as interact with the service 111 to provide ratings, comments and other features supported by the service 111.

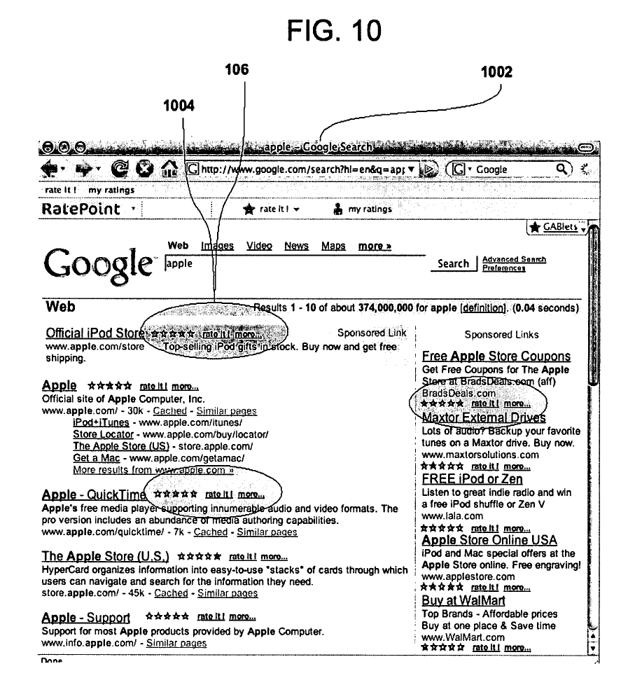

FIG. 10 illustrates an example of the how the rating service could be represented when a participant visits and interacts with a supported eco-system, which is supported by the rating service. In this particular example, the supported site is Google, as being part of and identified and supported eco-system. In addition to Google, other similar sites and additional search providers are supported, including but not limited to, Yahoo!, MSN and ASK.

The overlay 106 is made available to participants 102 while using the toolbar 102 and visiting a particular web site 108 or page that is defined as a supported eco-system within the service 111. Specifically, in this example the supported eco-system is the Google search engine which allows users of their service to get access to information by performing a general search query. When a service 111 participant 102 has a toolbar 104 which is configured to have access to and detection services for a particular supported eco-system the traditional overlay as described in FIG. 6, FIG. 7, FIG. 8, and FIG.9 is able to enable additional overlay support for specific page objects and/or elements within the web site 108 of the supported eco-system. In this particular example, as the participant 102 performs traditional search queries within the Google search service specific page elements are evaluated and extracted for submission to the service 111. In its basic form the URLs/URI's of each section of the results page will be submitted to the service 111 for rating evaluation. The service 111 then takes each of these requests and performs a rating lookup and prepares a response to send back to the overlay 106 which is represented in a rating block 1004. The request from the overlay 106 to the service 111 can be in batch or individual mode and cam be done without the toolbar if the web site 108 has the capability to embed the initial script calls. When the responses are returned to the overlay 106 each rating result is associated with the proper page object or element and attached or positioned closely as to show a connection to the specific object or element in the web site 108 page. In addition to the rating information being displayed, the participant 102 has the ability to utilize common functions associated with each rating such as the ability to provide a rating, see more about the rating details etc. If the participant elects to provide a rating, the overlay can either direct the participant 102 to a rating collection page at the service 111 and upon completion return the participant 102 back to the page where the rating was initiated, or the overlay 106 could display a form for rating collection in a traditional popup window or an embedded script formatted window which could make use of standard transport technologies such as XML over HTTP to submit the rating information. In addition, the participant 102 could elect to see more rating information pertaining to the specific object or element within the web site 108 page and this additional information could too be displayed in a traditional popup window or within an embedded script formatted window which could make use of standard transport technologies such as XML over HTTP to display the additional rating information.

An obvious advantage of this model is that the participant 102 is not required to leave the web site 108 page in order to see rating information pertaining to each of the links and results returned in the search query. Nor, is the participant 102 required to visit each an every link or search query result that is displayed to obtain real-time rating information about the object or element.

In addition to the additional overlay 106 support that is available based on the web site 108 of the supported eco-system the traditional overlay 106 support that is described in FIG. 6, FIG. 7, FIG. 8, and FIG. 9 is available as well.

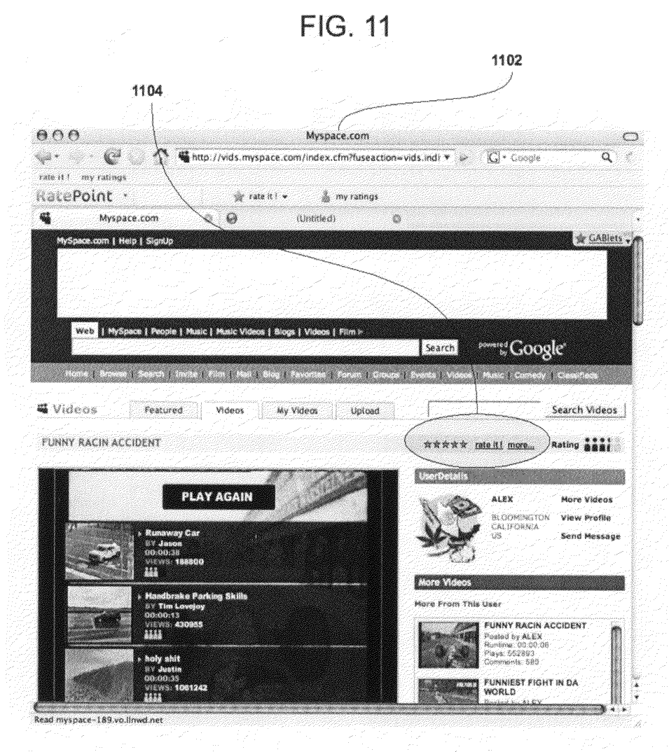

FIG. 11 illustrates an example of the how the rating service could be represented when a participant visits and interacts with a supported eco-system, which is supported by the rating service. In this particular example, the supported site is MySpace, as being part of an identified and supported eco-system. In addition to MySpace, other similar sites and additional services offering similar capabilities are supported.

The overlay 106 is made available to participants 102 while using the toolbar 102 and visiting a particular web site 108 or page that is defined as a supported eco-system system within the service 111. Specifically, in this example the supported eco-system is MySpace. The MySpace environment allows is users to post web pages about themselves, have access to others, communicate within the community and perform other social related tasks. As part of this service users of the service often review materials from other users, examine videos and other things which promote the rating of the material. In this particular case the MySpace environment has an internal rating system that is made available in specific sections and portions of the service. With preferred embodiments of the invention, the ability to expand the rating for the MySpace web site 108 pages is made available through the standard overlay 106. In addition, similar to the additional overlay 106 support described in FIG. 10, preferred embodiments may allow participants 102 of the service 111 to provide rating information on objects and/or elements within the web site 108 pages. For example when a MySpace user or general Internet user is viewing a specific video, or viewing a specific MySpace user profile page on the MySpace service the rating information displayed and correlated with objects and/or elements within the pages is delivered by the proprietary MySpace rating service. With the standard and additional overlay 106 support provided by certain embodiments of the invention, a MySpace user or general Internet user who is a participant 102 in the service 111 would have access to additional rating information which is delivered and presented in an overlay 106 fashion by the service 111. In addition, all the web site 108 pages and objects and/or elements that having rating associated with them are available for anonymous and participants 102 of the service 111 to view and interact with on the service 111 Web service 112.

Just as described in FIG. 10 in addition to the rating information being displayed, a participant 102 has the ability to utilize common functions associated with each rating such as the ability to provide a rating, see more about the rating details etc. If the participant elects to provide a rating, the overlay can either direct the participant 102 to a rating collection page at the service 111 and upon completion return the participant 102 back to the page where the rating was initiated, or the overlay 106 could display a form for rating collection in a traditional popup window or an embedded script formatted window which could make use of standard transport technologies such as XML over HTTP to submit the rating information. In addition, the participant 102 could elect to see more rating information pertaining to the specific object or element within the web site 108 page and this additional information could too be displayed in a traditional popup window or within an embedded script formatted window which could make use of standard transport technologies such as XML over HTTP to display the additional rating information.

An obvious advantage of this model is that the participant 102 is not required to leave the web site 108 page in order to see rating information pertaining to each of the links and results returned in the search query. Nor, is the participant 102 required to visit each an every link or search query result that is displayed to obtain real-time rating information about the object or element.

In addition to the additional overlay 106 support that is available based on the web site 108 of the supported eco-system the traditional overlay 106 support that is described in FIG. 6, FIG. 7, FIG. 8, and FIG. 9 is available as well.

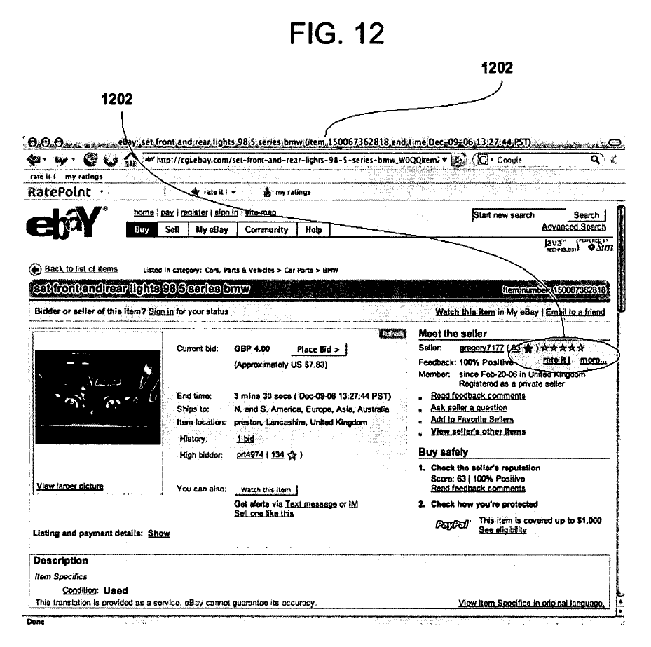

FIG. 12 illustrates an example of the how the rating service could be represented when a participant visits and interacts with a supported eco-system, which is supported by the rating service. In this particular example, the supported site is eBay, as being part of an identified and supported eco-system. In addition to eBay, other similar sites and additional services offering similar capabilities are supported.

The overlay 106 is made available to participants 102 while using the toolbar 102 and visiting a particular web site 108 or page that is defined as a supported eco-system within the service 111. Specifically, in this example the supported eco-system is eBay. The eBay service environment allows is users to post and participate in auction activities. A common need in these types of environments is the need for the purchasing user to have the ability to evaluate the reputation of a seller before completing or even starting to participate in a transaction. Systems like eBay have a basic rating system but this is only available to participants within the eBay community and not available to people when they are not visiting the eBay community. In this example while reviewing a specific item that is available for auction the participant 102 has immediate access to the rating information known to the service 111. As such, the participant can visit the service 111 and review more information about the particular seller, or additional sellers by searching the service 111 pages for the needed information about the eco-system and its users. With certain embodiments of the invention, the ability to expand the rating for the eBay web site 108 pages and the objects and/or elements within them (for example a users profile page, or a particular product page) is made available through the standard overlay 106. In addition, similar to the additional overlay 106 support described in FIG. 10 certain embodiments of the invention can allow participants 102 of the service 111 the ability provide rating information on objects and/or elements within the web site 108 pages. For example when a eBay user or general Internet user is viewing a specific auction or user profile page on the eBay service the rating information displayed and correlated with objects and/or elements within the pages is delivered by the proprietary eBay rating service. With the standard and additional overlay 106 support provided by certain embodiments of the invention, an eBay user or general Internet user who is a participant 102 in the service 111 would have access to additional rating information which is delivered and presented in an overlay 106 fashion by the service 111. In addition, all the web site 108 pages and objects and/or elements that having rating associated with them are available for anonymous and participants 102 of the service 111 to view and interact with on the service 111 Web service 112.

Just as described in FIG. 10 in addition to the rating information being displayed, a participant 102 has the ability to utilize common functions associated with each rating such as the ability to provide a rating, see more about the rating details etc. If the participant elects to provide a rating, the overlay can either direct the participant 102 to a rating collection page at the service 111 and upon completion return the participant 102 back to the page where the rating was initiated, or the overlay 106 could display a form for rating collection in a traditional popup window or an embedded script formatted window which could make use of standard transport technologies such as XML over HTTP to submit the rating information. In addition, the participant 102 could elect to see more rating information pertaining to the specific object or element within the web site 108 page and this additional information could too be displayed in a traditional popup window or within an embedded script formatted window which could make use of standard transport technologies such as XML over HTTP to display the additional rating information.

An obvious advantage of this model is that the participant 102 is not required to leave the web site 108 page in order to see rating information pertaining to each of the links and results returned in the search query. Nor, is the participant 102 required to visit each an every link or search query result that is displayed to obtain real-time rating information about the object or element.

In addition to the additional overlay 106 support that is available based on the web site 108 of the supported eco-system the traditional overlay 106 support that is described in FIG. 6, FIG. 7, FIG. 8, and FIG. 9 is available as well.

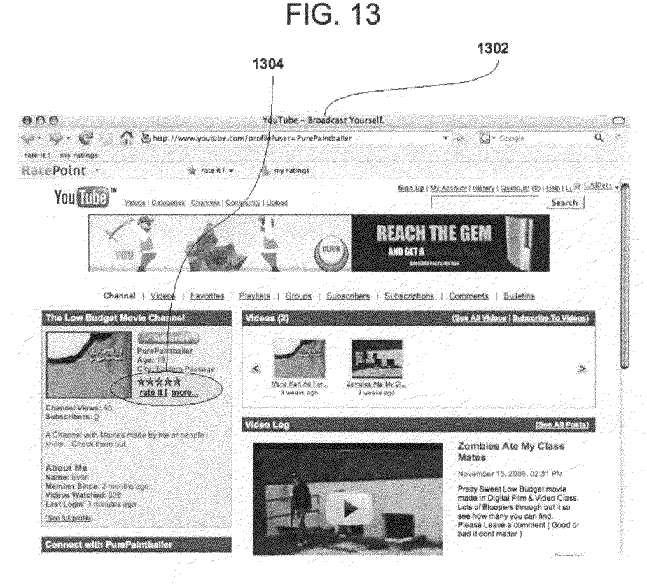

FIG. 13 illustrates an example of the how the rating service could be represented when a participant visits and interacts with a supported eco-system, which is supported by the rating service. In this particular example, the supported site is YouTube, as being part of an identified and supported eco-system. In addition to YouTube, other similar sites and additional services offering similar capabilities are supported.

The overlay 106 is made available to participants 102 while using the toolbar 102 and visiting a particular web site 108 or page that is defined as a supported eco-system within the service 111. Specifically, in this example the supported eco-system is YouTube. The YouTube service environment allows its users to create profile pages, post videos and other information to the service. In addition, YouTube allows its users to maintain a site, which serves as a home page of sorts to show and provide access to their videos and allows other users of the system and general Internet users to view and provide basic rating input. As with most proprietary silo style rating environments the ratings and comments can only be viewed and interacted with internal to the specific system. Because of this, a common need in these types of environments is to allow the ratings and comments pertaining to the content of the overall web sites and the content, objects and/or elements within to be accessed and interacted with outside of the silo rating environment. In addition, also allowing people who are not members of the specific environment to be involved as well is available. Preferred embodiments of the invention fill this need and allow both participants of the service 111 and the supported eco-system to interact within the same rating environment.

In this example when a participant 102 of the service 111 visits this web site 108 page the information from the page is sent to the service 111, including the URL/URI. Based on the information contained in the service 111 about this particular web site 108 page and objects and/or elements within it the toolbar 104 and the overlay 106 will represent the rating information and access to rating information as appropriate. Specifically in this example, the service 111 has rating information pertaining to this specific YouTube user profile. This rating block 1304 is then displayed within the browser rendering area and closely coordinated with the object and/or element in which it is attached. Just as described in FIG. 10 in addition to the rating information being displayed, a participant 102 has the ability to utilize other common functions associated with each rating that are located within the rating block 1304 such as the ability to provide a rating, see more about the rating details, and enter comments etc. If the participant elects to provide a rating or comment, the overlay can either direct the participant 102 to a rating collection page at the service 111 and upon completion return the participant 102 back to the page where the rating was initiated, or the overlay 106 could display a form for rating collection in a traditional popup window or an embedded script formatted window which could make use of standard transport technologies such as XML over HTTP to submit the rating information. In addition, the participant 102 could elect to see more rating information pertaining to the specific object or element within the web site 108 page and this additional information could too be displayed in a traditional popup window or within an embedded script formatted window which could make use of standard transport technologies such as XML over HTTP to display the additional rating information.

In addition to the participant 102 having access to this rating information displayed in the toolbar 104 and overlays 106 when they visit specific web sites 108 that are port of the services 111 supported eco-systems, the participants 102 and anonymous users can see all rating information pertaining to all supported eco-systems by visiting the web service 112 directly. Therefore bring the specific eco-system rating information outside the close silo making more accessible to more users and participants 102.

An obvious advantage of this model where the rating information is delivered to the participant 102 is that the participant 102 is not required to leave the web site 108 page in order to see rating pertaining to it or objects and/or elements within it.

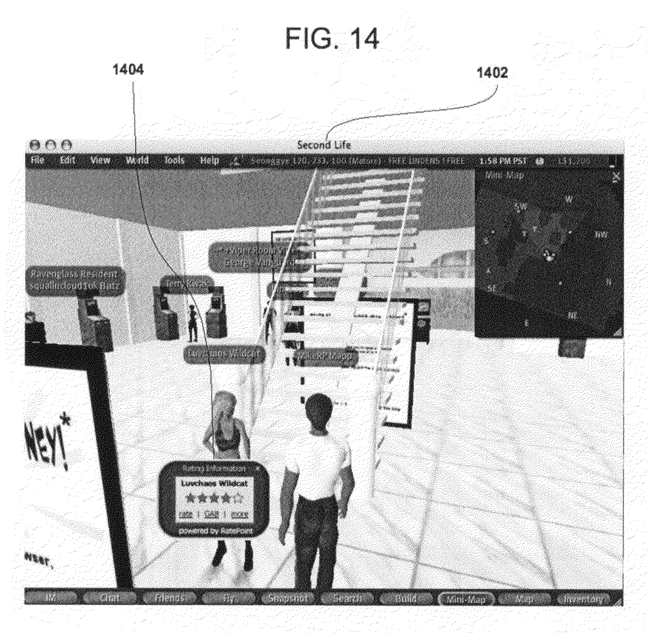

FIG. 14 illustrates an example of the how the rating service could be represented when a participant visits and interacts with a supported eco-system, which is supported by the rating service. In this particular example, the supported service is Second Life, and online game that allows people to participate in a virtual life game defined as a “Second Life”. In addition to Second Life, other similar games and additional services offering similar capabilities can be supported.

This is an example of the service 111 when integrated and working inside of gaming 103 environments. In this particular example the service 111 is working with the popular online game called Second Life. In this particular environment, participants 102 of the service 111 can have access to rating information, which is sponsored by participants 102 of the service 111. In this case, the participant 102 of the service has chosen enable and install the service 111 gaming 103 tools for integration into the Second Life game environment. As the participant 102 traverses in the Second life gaming environment the ability to receive real-time rating information for objects within the game including but not limited to, avatars, buildings, products, stores, processes and other things becomes available. Buy making focus on or targeting an object within the game a call will be made to the service 111 to obtain information about the object. In addition, the participant has the ability to provide a rating as well as comments about an object. This information will be made available to other participants 102 of the service 111 as well as to the any anonymous users that visit the service web service 112 environment and pages.

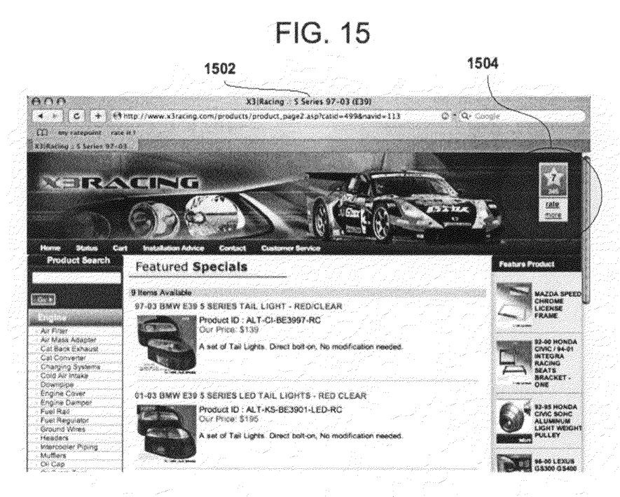

FIG. 15 is an example of a merchant participant 102, and in this particular case incorporating a rating badge 1504 by utilizing the API service 110. In this particular example, the merchant participant 102 wants to represent its rating badge 1504 to other service 111 participants 102 as well non service 111 users visiting the merchant participants 102 web site 108. Through the use of the service 111 API service 110 the merchant participant 102 can place the same overlay 106 scripts and objects defined in FIG. 9 within the web site 108 pages when they want to show the rating badge 1504. As participants 102 of the service 111 get the overlay 106 capabilities when a toolbar 104 is installed, the merchant participant 102 in this case can display the overlays 106 and rating badge 1504 information to any user of the web site 108, whether a service 111 participant 102 or not. This is accomplished by placing the initiating script for the overlay 106 in each web site 108 page where they wish to make the rating badge 1504 and overlays 106 visible. The common rating and commenting abilities are also extended to the participant 102.

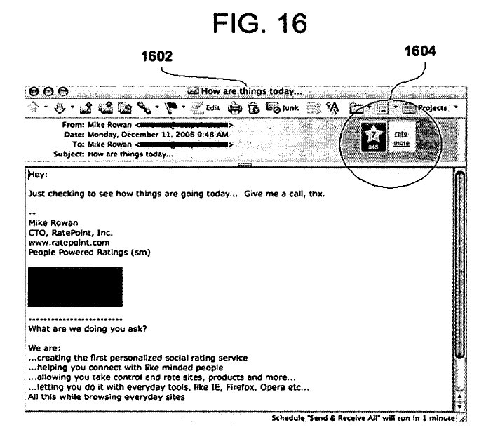

FIG. 16 is an example of a participant 102, utilizing a mail 107 application and in this particular case incorporating a rating badge 1604 by utilizing the API service 110. In this particular example, the participant 102 is reviewing an email and the rating badge 1604 displayed is rendered after a call to the service 111. Through the use of the service 111 the participant can access more details about the email sender similar to how they could do this when interacting with a web site 108. The ability to participate, provide ratings, comments is made available by utilizing additional links and functions as part of the rating badge 1604, or can be accessed via a toolbar 104 which is installed into the mail 107 application.

Finally, just as the service 111 allow participants 102 to benefit from the like and similarities of other participants 102, certain embodiments also leverage the dislikes and the fact that participants 102 may be nothing like one another. For example, if a participant 102 is viewing rating and other content within the Web service 112 and while doing so elects to view his or her social circle, or socialverse (A service 111 term for the social universe of a participant, a calculated social circle, for example, see incorporated patent application identified above) the participant would have immediate access to see which other participants 102 within the service 111 are close to them. During this review process, the participant 102 has the ability (as well as any other time when in the Web service 112) to view the rating details and trends of other participants 102. A participant can easily spot a rogue, or non ethical participant, and if they wish remove them from the social circle, or socialverse that has been put forward by the service 111 so as not to be affected in the future by this particular participant 102 in any way at all. The ability for participants 102 to actively engage with other participants 102, add, remove and shuffle participants 102 in and out of their social circle is always an override option the participant 102 has a right to do.

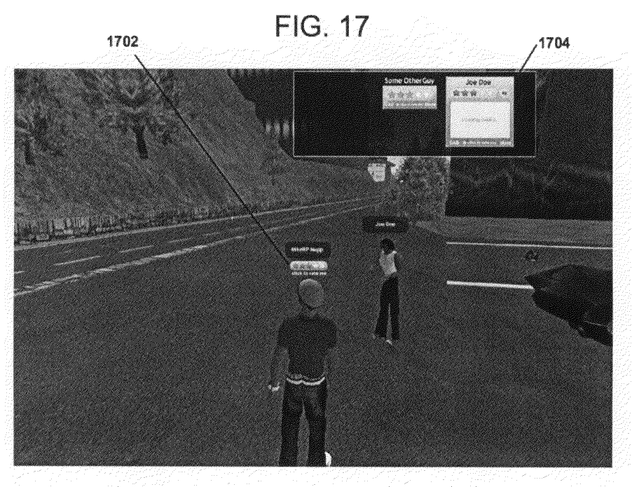

FIG. 17 is an example of a gaming add-on 103, in this particular case the gaming environment is the Second Life environment that can be utilized by a participant 102 in the rating service 111 or by non-participants who are not participants in the rating service. In the following discussion, non-participants will also be referred to as users or observers in the gaming environment. It provides an example of the how the rating service could be represented when a participant visits and interacts with a supported eco-system, which is supported by the rating service. In this particular example, the supported service is Second Life, introduced in FIG. 14, an online game that allows people to participate in a virtual life game. In addition to Second Life, other similar games and additional services offering similar capabilities can be supported.

This gaming add-on 103 has two (2) main components that consist of the following, a community view and a private view. The community view presents a Community Badge 1702 which allows a participant to display a badge to other participants 102, users and observers which allow the participants 102 rating information to be seen as well as interact with a participant 102 and the participants 102 rating information. The private view presents a Private Panel 1704 which allows participants 102 to have quick and convenient access to all gaming participants 102, users and observers in a private view panel which is automatically updated with rating information as gamers move into the participants 102 viewing pane. The participant is also able to view information, such as ratings and gablets as well as rate and have access to details of the garners profile information on the rating service 111.

The Community Badge 1702 displaying participant 102 rating information is displayed in a fixed proximity to the participant 102, within the environment. The Community Badge 1702 position on the display is determined by the position of the participant's 102 image on the display. In preferred embodiments, the Community Badge 1702 is displayed over the head of the participant 102 image in a position determined by or attached to the position of the pelvis of the participant 102 image in the display. Alternately, the user could elect to display the Community Badge 1702 in a different position by electing to attach the rating object to another part of the participant image. Setting options are provided to the participant 102 enabling the participant to elect the display position of the community badge 1702.

Additionally, in preferred embodiments, when users of the Second Life environment choose to be participants 102 of the rating service 111 the Second Life user is directed to a signup application located on the rating service 111 web service 112, which allows the rating service 111 to collect basic information about the Second Life user, such as Avatar name, email address and any other relative information. The rating service 111 then sends the new participant 102 an email with a SLURL (Second Life URL) witch directs the new participant 102 to a location within the Second Life environment to complete the registration process. Once the process is completed the rating service 111 sends what is called a Ratepack, which consists of a community view 1702 which is an attachment and a private camera view 1704 which is a Heads-Up Displays (HUD) as well as other needed materials such as a notecard outlining instructions etc. to the participants' 102 inventory, as provided by SecondLife. When the participant 102 accepts this offer, the items are then added to the inventory of the participant 102 in the Second Life environment. These objects which consist of an attachment, HUD and other needed materials and objects can then be worn to be displayed and used appropriately with the rating service 111. HUDs are a special form of attachment point, or object tied to SecondLife body. Unlike normal attachment points on the body, they maintain a fixed position on the participant or user's screen and are only visible to that particular participant or user.

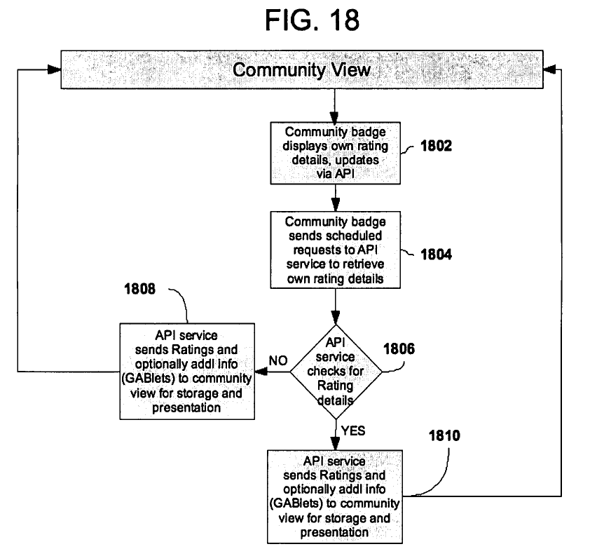

FIG. 18 is an example process flow showing how the community badge 1702 rating information which is worn by participants 102 of the rating service 111 is keep up to date for outward presentation to other participants 102, users and observers within the gaming environment. In step 1802 the community badge presents the arithmetic mean rating information for the participant 102 wearing and presenting the community badge 1702 for display. In addition, if needed the community badge itself can detect participants 102, users and observers in close vicinity and update its ratings details appropriately. For example, if the community badge 1702 detects a participant 102 of the rating service 111 who has rated on the participant 102 wearing the community badge 1702 the rating service 111 could return the detected participants 102 submitted rating for display in the community badge 1702.

In another example, if the community badge 1702 detects a participant 102 in the ratings service 111 who is a member of the detected participants 102 social circle the community badge 1702 could return the detected participants 102 arithmetic social circle rating (as is detailed in pending U.S. patent application Ser. No. 11/639678, entitled System and Method for Determining Behavioral Similarity Between Users and User Data to Identify Groups to Share User Impressions of Ratable Objects, the entire contents of which are herein incorporated by reference) for display in the community badge 1702. In step 1804 the community badge 1702 sends periodic requests to the rating service 111 to update the community badge 1702 display. The schedule of these updates can be set to any time interval, for example every 1 hour a request could be made to the rating service 111. In standard operation, the request would retrieve the arithmetic mean for community badge 1702 display, but if needed by setting manually or as an automated option the request could retrieve the arithmetic social mean or the exact rating for community badge 1702 display. In addition to the community badge 1702 requesting ratings from the rating service 111, specific information such as GABlet counts and optionally additional information could be returned in the update request response. This information could too be displayed via the community badge 1702 and made available. In step 1808, the actual request is made to the rating service 111 which will respond with the appropriate rating information for community badge 1702 display. If specific rating information is not available for the participant 102 that is making the request to the rating service 111 via the community badge 1702 then the rating service 111 returns information updating the community badge 1702 informing the non participant, user or observer that they can be the first to rate this participant 102 as defined in step 1806. If rating information is found, as shown in step 1810, the rating service 111 send back the rating and optionally addition information such as GABlet counts to the community badge 1702 for display to the non participant, user or observer.

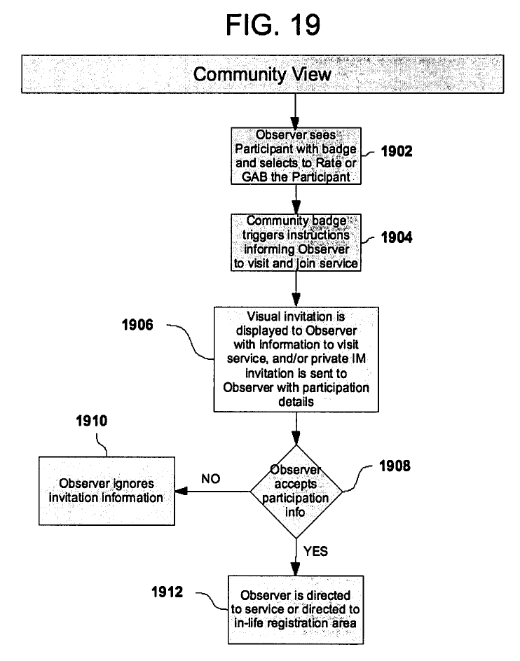

FIG. 19 is an example process flow of the Community Badge View and the process that occurs when a user or observer of the environment is attempting to rate or GAB about a participant. It shows what occurs when the community badge 1702 rating information which is worn by participants 102 of the rating service 111 is selected or interacted with by non participants, users or observers in the gaming environment. In step 1902 a non participant, user or observer encounters a participant 102 of the rating service 111 and notices the community badge 1702 which is displayed in relation to the participant 102. The non participant, user or observer selects the option to submit a rating and optionally additional information for the participant 102 by interacting with the community badge 1702. In step 1904 the community badge 1702 triggers an information notification to the non participant, user or observer instructing them that in order to rate on a participant 102 they must first be a registered user.

As described in step 1906 the visual information notification can be delivered in one or more ways and in combination. For example, an information dialog using the standard Second Life traditional notification window which slides down from the upper right hand portion of the game users screen would display information about the participant 102 that the non participant, user or observers is trying to rate. In addition, information would be displayed allowing the non participant, user or observer to learn more about the rating service 111. The display would provide links and more information to learn more about the rating service 111 and/or the participant 102 whom the non participant, user or observer is trying to rate. The information dialogue would also have the ability to send a private or public IM (Instant Message) to the non participant, user or observer with the information display as described above. Or, as another alternative or in addition to the window information display or the IM information display, note cards or other forms of standard internal notifications could be presented. In step 1908 the non participant, user or observer can choose to accept the informational request and selecte a link or button provided within the information. Or, the non participant, user or observer can choose to ignore the request by simply selecting the ignore button or other mechanism provided to ignore the information. If the non participant, user or observer chooses to ignore the information as described in step 1910, the information window is closed, or the IM and other communication methods can be ignored or deleted. In step 1912 if the non participant, user or observer chooses to accept or participate in the information provided they can utilize a link, button or other mechanism provided to see and have access to the additional information. The typical options in this case would be to signup and become a member of the rating service 111, which would either direct the non participant, user or observer to the signup application which is located at the rating service 111 web service 112 pages, or to the in-life (Second Life) location where the non participant, user or observer can start the signup process in-life, directly in side the gaming environment. Alternatively the non participant, user or observer could elect to see more about the rating service 111, or more about the participant 102 whom they are attempting to rate. In this case, they could be directed to the rating service 111 web service 112 pages to review information about the service, see the participants 102 profile, ratings, GABlets and other information, or they could be directed to the in-life location and start the informational process from within the gaming environment.

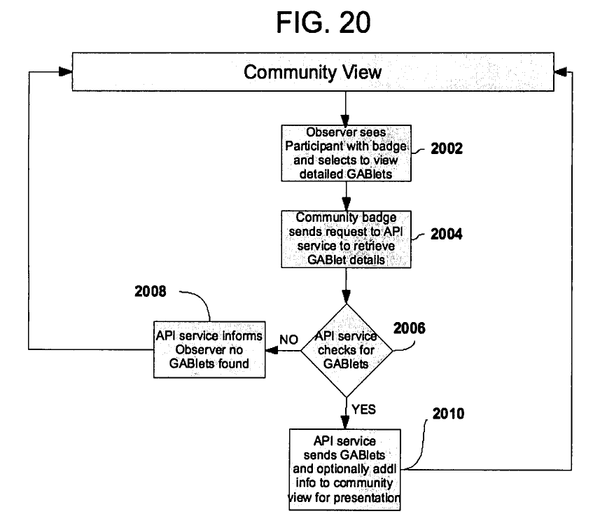

FIG. 20 is an example process flow of the Community Badge View and the process that occurs when a user or observer of the environment is attempting to review gabs about a participant. It shows what occurs when the community badge 1702 rating information which is worn by participants 102 of the rating service 111 is selected or interacted with by non participants, users or observers in the gaming environment. In step 2002 a non participant, user or observer encounters a participant 102 of the rating service 111 and notices the community badge 1702 which is displayed in relation to the participant 102. The non participant, user or observer selects the option to view GABlet information for the participant 102 by interacting with the community badge 1702. In step 2004 the community badge 1702 sends a request to the rating service 111 API service 110 to retrieve the needed GABlet information for the participant 102. In step 2006 the API service 110 checks for any GABlet information related to the participant 102. As described in step 2008, if no GABlet information is found the API service 110 information the non participant, user or observer of this. If GABlet information is found for the participant 102 as described in step 2010, the API service 110 sends back the most recent GABlets to the community badge 1702 for display. The community badge 1702 then displays the GABlet information in the Second Life traditional notification window in the upper right hand corner of the non participant, user or observers screen. In addition, the standard service information such as ability to signup, see more etc is displayed to the non participant, user or observer as described in FIG. 19. In addition as described in FIG. 19 addition information notifications can be sent to the non participant, user or observer such as public or private IM messages etc. Also, the GABlet information could be displayed in a window attached or in relation to the community badge 1702.

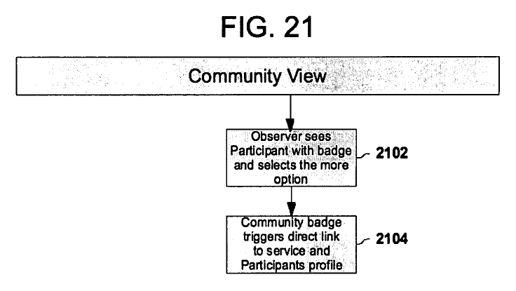

FIG. 21 is an example process flow of the Community Badge View and the process that occurs when a user or observer of the environment is attempting to review more about a participant. It shows what occurs when the community badge 1702 rating information which is worn by participants 102 of the rating service 111 is selected or interacted with by non participants, users or observers in the gaming environment. In step 2102 a non participant, user or observer encounters a participant 102 of the rating service 111 and notices the community badge 1702 which is displayed in relation to the participant 102. The non participant, user or observer selects the option to view more information for the participant 102 by interacting with the community badge 1702. In step 2104 the community badge 1702 triggers a informational message which is displayed in the Second Life traditional notification window which allows the non participant, user or observer to visit the participants 102 profile page(s) on the ratings service 111 web service 112 site. In addition, the more option could directly send non participants, users or observers to the rating service 111 web service 112 without prompting them, and open the web browser for the destination immediately. As an alternate option, the non participant, user or observer could also be directed to the in-life (virtual) location to start the process of obtaining and seeing more information about the selected participants 102 profile or the rating service 111.

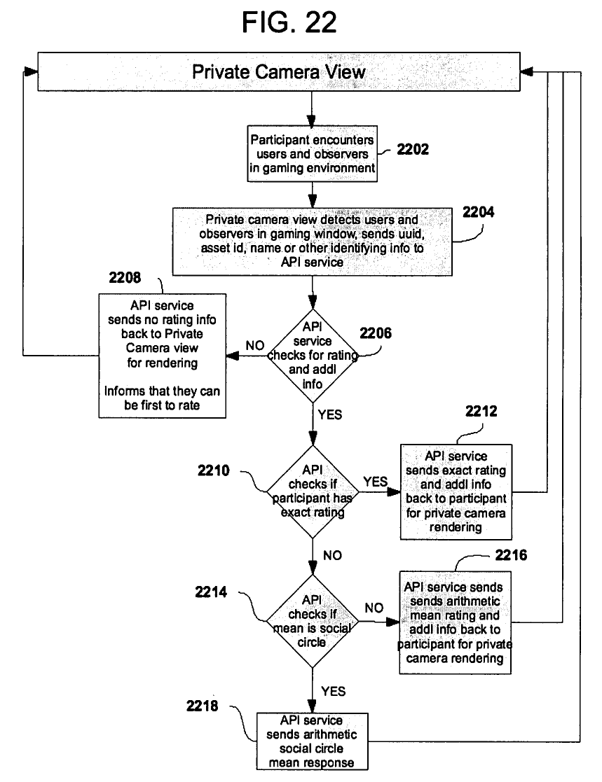

FIG. 22 is an example process flow of the Private Camera View and the request and delivery process while a participant of the environment is exploring and encountering other people objects, and elements within the environment. It shows how the private camera view 1704 which is worn by participants 102 of the rating service 111 and is updated for inner presentation to the participant 102 wearing the private camera view 1704 within the gaming environment. In step 2202 when a participant 102 encounters other Second Life users who may or may not be participants 102 in the rating service 111, whom we will refer to as encountered users, rating information about the encountered user is retrieved from the rating service 111 API service 110. In step 2204 when the private camera view 1704 detects an encountered user which is based on a preset or automatic perimeter setting, or manual selection the private camera view 1704 sends individual or bulk requests to the rating service 111 API service 110 to receive rating and other information such as GABlet information. An encounter triggers the delivery of information to the private camera view when a participant comes in proximity to other Second Life users within the preset or automatic perimeter setting. In preferred embodiments this perimeter surrounds the user at a 5-7 meter radius, as measured in the geography of the virtual environment in Second Life, though other determinants of perimeter may be preferred in other embodiments.

The rating service 111 uses unique identifiers to enable ratings for Second Life ratable entities. The rating service 111 is capable of identifying a variety of assets, agents and simulators. In preferred embodiments of the Second Life environment the rating service utilizes UUID, Asset ID, Object ID, Avatar name, etc. Other identifies may be preferred in alternate embodiments. In certain Second Life embodiments, the simulator includes the place (e.g. the portion of land and all the processes on it), the agents include the people (e.g. the avatars), and the assets include everything that can exit on an agent or a simulator (e.g. asset ID, object ID, metadata type, etc.). As described below, in preferred embodiments, a participant 102 is able to rate an encountered user who is identified by a uuid.

When an encounter occurs, the private camera view 1704 sends unique identifiers that are made available about the encountered user, such as uuid asset id, avatar name information etc. In this particular example the uuid of the encountered user along with the uuid of the participant 102 with other parameters needed to inform the API service 110 of the type of request are sent to the API service 110. In step 2206 the API service 110 checks to see if there is existing rating and other information such as GABlets. In step 2208 if no information is found the API service 110 sends back a no rating information response to the private camera view 1704 letting the participant 102 know that there are no ratings for the encountered user.

In addition, the participant 102 is made aware that they can be the first to rate this encountered user. In step 2210 if rating information is found for the encountered user it is first analyzed to determine if this rating information matches an exact rating provided to the rating service 111 by the participant 102 about the encountered user. If it is determined that there is an exact rating the API service 110 returns this exact rating and other additional information as needed back to the private camera view for display to the participant 102 as described in step 2212. If it is determined that the rating information is not an exact rating in step 2214 the API service 110 now check to see if the rating is as result of a social circle calculation, if it is determined that this rating is not a result of a social circle calculation then as described in step 2216 the API service 110 send back the arithmetic mean rating and other additional information to the private camera view for display to the participant 102. If determined in step 2214 that this rating is a result of a social circle calculation then in step 2218 the API service 110 sends a arithmetic social mean rating to the private camera view 1704 for display to the participant 102. The private camera view 1704 has the ability to discover the current maximum encountered users capable by the Second Life gaming environment. Currently up to sixteen (16) individual encountered users can be discovered at any one time and the associated encountered user rating information can be displayed it private camera view 1704 at one time. The private camera view 1704 can be customized on the number of encountered users that will be shown at any one time in the private camera view, from zero (0) to sixteen (16). In addition, the private camera view 1704 can be customized to show encountered users rating information in an automatic or manual mode. If set to automatic, the encountered users rating information will automatically appear in the private camera view and be updated based on proximity or manual override. Or, if set to manual mode, only when a request is made to show a particular encountered users rating information will it be displayed in the private camera view 1704.

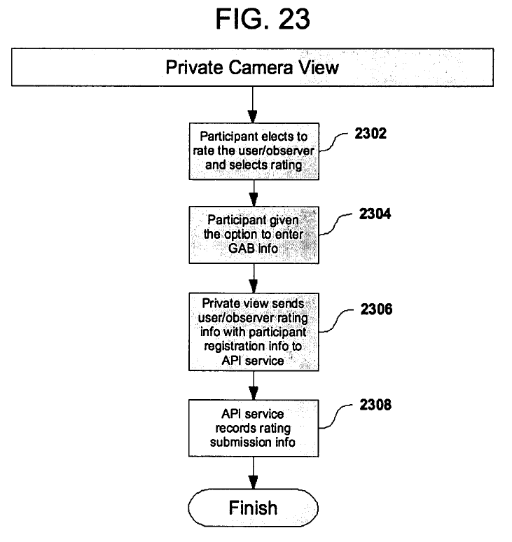

FIG. 23 is an example process flow of the Private Camera View and the process that occurs when a participant of the environment elects to rate on a particular user, observer, people, objects or other elements in the environment. It shows how the private camera view 1704 which is worn by participants 102 of the rating service 111 is utilized to submit rating information by the participant 102 wearing the private camera view 1704 for encountered users within the gaming environment. In step 2302 when a participant 102 elects to supply a rating for an encountered user the participant 102 is presented with the ability to select the rating via the rating service 111 standard rating mechanism. This rating selection process is performed within the private camera view 1704 in relation to the encountered users presented rating information.

In this particular case the participant 102 selects the appropriate star to indicate the rating value for the encountered user and once the participant 102 selects the rating in step 2304 the participant 102 is informed that they may also leave GABlets about the encountered user they have selected to rate. The participant 102 is informed in the standard Second Life traditional notification window. If the participant 102 elects to enter GABlets about the encountered user the participant 102 is instructed to enter the GABlet information in the traditional chat box available in the Second Life gaming environment. If the participant 102 enters GABlet information in the available chat box the participant 102 is then given the opportunity to review the rating and GABlet information before submission. This confirmation will also be displayed in the Second Life traditional notification window. In step 2306 once the participant 102 elects to commit the rating and GABlet information, the private camera view 1704 send the required information to the API service 110 to complete the rating process. The information sent in step 2306 at a minimum consists of a participants 102 uuid, the encountered user uuid, and avatar name, rating values selected by participant 102, gablet information as well as other needed parameter information for the API service 110 to handle this particular submission.

In addition, during the rating submission process to the API service 110 a private IM message is sent to the encountered user whom was just rated, informing them of the rating and providing a link to the rating service 111 web service 112 pages to see their profile and learn more and signup for the rating service 111. The IM sent in this case can be public and/or private, and optionally other in-life common communication forms may be used such as note cards etc. In step 2308 the API service 110 validates and records the rating information. Just as in the other notification areas defined within this document which take advantage of the Second Life traditional notification window, the ability to present input and notification windows attached to in the area of the rating selectors is optionally done. The use of the Second Life traditional notification window make the service work more seamlessly within the environment and is easy for users to understand and interact with.

When the participant 102 elects to leave GABlets about the encountered user or object they have selected to rate they may enter GAB info in two forms. The participant 102 may select from a set of provided and preexisting sentences to convey rating information. Alternately, the participant 102 may create their own customized sentence that can be recorded textually. In each case the information is sent to the API service 110 that validates and records the rating information, step 2308 and interprets rating information.

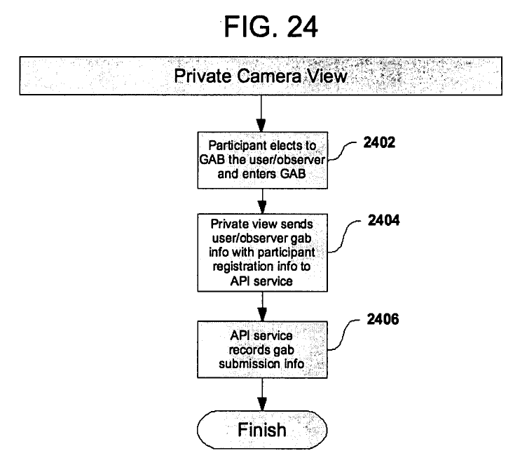

FIG. 24 is an example process flow of the Private Camera View and the process that occurs when a participant of the environment elects to gab on a particular user, observer, people, objects or other elements in the environment. It shows an example process flow showing how the private camera view 1704 which is worn by participants 102 of the rating service 111 is utilized to submit GAB information by the participant 102 wearing the private camera view 1704 for encountered users within the gaming environment. In step 2402 when a participant 102 elects to supply a GAB for an encountered user the participant 102 is presented with the ability to enter GAB information in the standard chat box in the gaming environment.

In this particular case the participant 102 selects the appropriate action to leave a GAB for the encountered user and once the participant 102 selects to leave a GAB the participant 102 is informed in the standard Second Life traditional notification window to enter the GABlet information in the traditional chat box available in the Second Life gaming environment. If the participant 102 enters GABlet information in the available chat box the participant 102 is then given the opportunity to review the GABlet information before submission. This confirmation will also be displayed in the Second Life traditional notification window. In step 2404 once the participant 102 elects to commit the GABlet information, the private camera view 1704 send the required information to the API service 110 to complete the GABlet submission process. The information sent in step 2404 at a minimum consists of a participants 102 uuid, the encountered user uuid, and avatar name, gablet information as well as other needed parameter information for the API service 110 to handle this particular submission.

In addition, during the rating submission process to the API service 110 a private IM message is sent to the encountered user whom was just rated, informing them of the rating and providing a link to the rating service 111 web service 112 pages to see their profile and learn more and signup for the rating service 111. The IM sent in this case can be public and/or private, and optionally other in-life common communication forms may be used such as note cards etc. In step 2406 the API service 110 validates and records the rating information. Just as in the other notification areas defined within this document which take advantage of the Second Life traditional notification window, the ability to present input and notification windows attached to in the area of the rating selectors is optionally done. The use of the Second Life traditional notification window make the service work more seamlessly within the environment and is easy for users to understand and interact with.

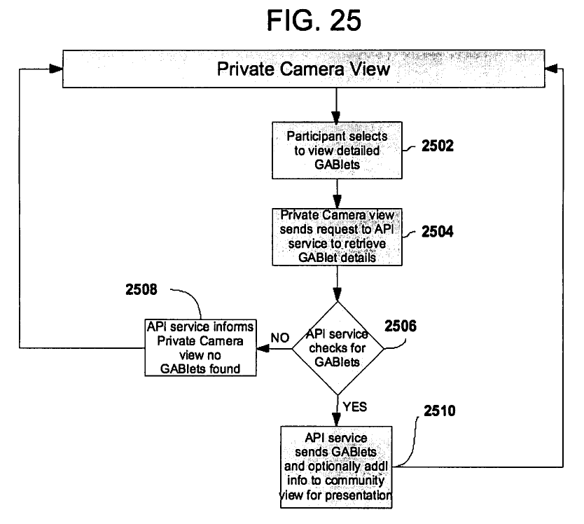

FIG. 25 is an example process flow of the Private Camera View and the process that occurs when a participant of the environment elects to review the gabs on a particular user, observer, people, objects or other elements in the environment. It shows how the private camera view 1704 which is worn by participants 102 of the rating service 111 is utilized to review GAB information by the participant 102 wearing the private camera view 1704 for encountered users within the gaming environment. In step 2502 when a participant 102 elects to review GABlets for an encountered user they do so by clicking the GAB information selection wttached to the encountered users rating section displayed in the private camera view 1704. In step 2504 the private camera view 1704 sends a request to the rating service 111 API service 110 to retrieve the needed GABlet information for the encountered user. In step 2506 the API service 110 checks for any GABlet information related to the encountered user. If no GABlet information is found in step 2506 the API service 110 returns a no GABlet found response to the private camera view 1704 for rendering to the participant 102 as described in step 2508. If GABlet information is found in step 2506 for the encountered user, the API service 110 sends back the most recent GABlets to the private camera view 1704 for display as described in step 2510. The private camera view 1704 then displays the GABlet information in the Second Life traditional notification window in the upper right hand corner of the participants 102 screen. In addition, the standard rating and other information such as encountered users profile, and see more etc is displayed to the participant 102.

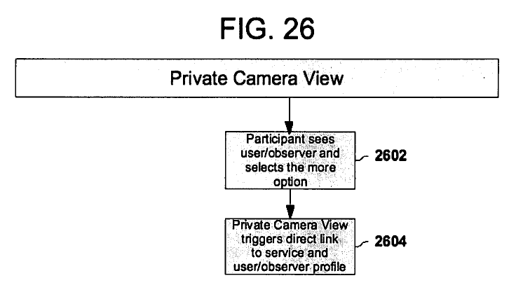

FIG. 26 is an example process flow of the Private Camera View and the process that occurs when a participant of the environment elects to see more on a particular user, observer, people, objects or other elements in the environment. It shows how the private camera view 1704 which is worn by participants 102 of the rating service 111 is utilized to review more information by the participant 102 wearing the private camera view 1704 for encountered users within the gaming environment. In step 2602 participant 102 sees an encountered user and sees the encountered users information about any ratings or GABlets in the private camera view 1704 in relation to the encountered user. The participant 102 selects the option to view more information for the encountered user by interacting with the rating information displayed in the private camera view 1704. In step 2604 the private camera view 1704 triggers a informational message which is displayed in the Second Life traditional notification window which allows the participant 102 to visit the encountered users profile page(s) on the ratings service 111 web service 112 site. In addition, the more option could directly send participants 102 to the rating service 111 web service 112 without prompting them, and open the web browser for the destination immediately. As an alternative option, the participant 102 could also be directed to the in-life location to start the process of obtaining and seeing more information about the selected encountered users profile or the rating service 111.

In yet another option, the participant 102 in the SecondLife gaming environment may have The rating information on their Second Life or in-life self to rating information or user profile information as determined from other ecosystem usage activities (e.g. websites visited, purchases made, etc.). For example, the social circle calculation for a given rating service participant could be calculated from a combination of Second Life usage and rating activities and from usage of websites on other supported ecosystems. When participants 102 of the rating service 111 initially creates accounts on the rating service 111, a traditional rating service 111 user account is also created, and the newly registered participant 102 has the ability to link these accounts together either privately, and/or publicly. When a new participant 102 elects to link the accounts privately, the participant 102 will have the ability to move from one account to another in the rating service 111 web service 112 site. In addition, if the accounts are linked publicly other traditional participants 102 and Second Life participants 102 of the rating service 111 will have the ability to see the participant's 102 linked accounts. Additionally, the rating service 111 can make the social aspects of the traditional participant 102 and the Second Life participant 102 work together and interact with and expand the social connections with other participants 102 in the rating service 111.

In preferred embodiments, the rating information and controls are co-presented with the user display (e.g. Second Life environment or other games) in a non-intrusive manner. While in certain embodiments, it may be preferable to present the rating information and controls as overlays positioned to one side of the user display, in other embodiments it may be preferable to integrate rating information and controls with the remainder of the user display (e.g. Second Life environment or other games).

For the rating service 111 to allow a user access to RatePoint information in regards to the site they are visiting a first part of the API is provided. It is a basic container available within the browser chrome. In other developments, the ability to interact within the browser-rendering window based on the users existing site and site category/type plays a critical role (i.e. search, auctions, buying sites, gaming environments etc.) API implementation steps for preferred Second Life embodiments, as detailed in preferred sequences of instructions and routines used in the computer program code, are provided.

Example API implementation steps are detailed below.
The “GetKey” API functions provides a basic level of security within the environment. GetKey API Functions provide a built-in basic HMAC feature for a basic level of security within the environment. In preferred embodiments, this particular function helps reduce fraud related activity to and from the RatePoint SL API environment. GetKey API Functions are provided in Table1.

TABLE 1
GetKey API Functions
URL: http://slapi.ratepoint.com/rating/slrating_getkey
METHOD: GET

GetKey
Message:
no parameters needed or expected
Response: of type - text/plain
ckey={base64_encoded_client_key} i.e.
mgfbUmBQGtDKMH94VEH_Tg==
wkey={base64_encoded_wrapped_key} i.e.
hua5jNhdbEfqSnidiFwM1A==
ttl={time_to_live_ms_since_1970} key is used until this time

GetKey Usage Information: The HMAC feature is available in the RatePoint SL API environment, allowing an HMAC to be returned when using the slrating_lookup and slrating_submit functions, as well as additional functions and application components as needed. When a client makes a request with a supplied key (wkey), RatePoint will use the supplied ckey along with other data to generate a HMAC. The key input to enable the HMAC response is a variable named “k” as described below. The HMAC is incorporated to the original text response from the API for a bit of security. A sample response is shown in the GetKey Usage Information section.

### GetKey Usage Information:

Sample:
ckey=dnBE7xVTexSLkjbYd9Uy3Q==
wkey=Woy12b9myhEdn4expt41UA==
Section 1: ttl=1172588936558
   GetKey Overview: When using the HMAC feature, the ability to compare the HMAC received from the RatePoint service must be performed as shown in the GetKey Overview section.

### GetKey Overview:

1. Create a MD5 context
2. Update the MD5 context with the SL RatePoint response content
3. Update the MD5 context with a separator “:ratepoint:”
4. Update the MD5 context with the ckey provided in the getkey response
5. Use a web safe Base64 encoding to encode the 128-bit MD5 digest.
The web safe base64 encoding algorithm used by RatePoint is as follows:
Replace “/” and “+” with “_” and “-” respectively in the regular base64 encoding algorithm
6. Utilize the resulting HMAC and compare with the returned HMAC information from the RatePoint response.
   Private View API functions include calls and returns used when a registered RatePoint-SL user has the private view enabled. Private View API information is shown in Table 2 Rating Lookup which looks up the relevant rating, Table 3 Gab Lookup which looks up the relevant GAB, Table 4 Rating Submit which shows how ratings are submitted, Table 5 Gab Submit which shows how Gabs are submitted, and Table 6 and Sl_user Check which determines whether a user is registered, below.

### Private View API

TABLE 2
Rating_Lookup
URL: http://slapi.ratepoint.com/rating/slrating_lookup?
METHOD: GET

```
Message:
c=sl
t=rtl
slreu={sl_uuid_of_ratee}
slrru={sl_uuid_of_rater}
k={wkey}
Response: of type - text/plain
rt={float_rating_value}
rtc={integer_rating_count}
t=[1,2,3]={1=user rating, 2=social rating, 3=aggregate rating}
gc={integer_gab_count}
k={hmac}
HAMC is calculated as follows:
  1. remove all carriage return and line feed characters from the output
  2. concatenate the above string with a predefined separator and client key
  3. use MD5 to hash the concatenated string to obtain the hmac.
Example, if the output is:
t=1
rt=3.5
rtc=80
gc=5
After removing all carriage return and line feed, it becomes
t=1rt=3.5rtc=80gc=5
then, hash this string and separator (currently is “:ratepoint:”) and client's key together.
The hash result becomes binary HMAC. The binary needs to be base64 encoded into a
printable string.
```

TABLE 3
Gab_Lookup
URL: http://slapi.ratepoint.com/rating/slgab_lookup?
METHOD: GET

```
Message:
c=sl
t=gl
slreu={sl_uuid_of_ratee}
slrru={sl_uuid_of_rater}
k=wkey
Response: of type - text/plain
gc={integer_gab_count}
g={most_recent_gab_text}||{next_most_recent_gab_text}||{most_recent_gab_text}
k={hmac}
HMAC is calculated as following:
  1. remove all carriage return and line feed characters from the output
  2. concatenate the above string with a predefined separator and client key
  3. use MD5 to hash the concatenated string to obtain the hmac.
Example, if the output is:
gc=2
g=comment 1||comment 2
After removing all carriage return and line feed, it becomes
gc=2g=comment 1||comment 2
then, hash this string and separator (currently is “:ratepoint:”) and client's key together.
The hash result becomes binary HMAC. The binary need to be base64 encoded into a
printable string.
```

TABLE 4
Rating_Submit (with/without Gab)
URL: http://slwww.ratepoint.com/sl/sl_submit?
METHOD: POST

```
Message:
c=sl
t=rts
slreu={sl_uuid_of_ratee}
slren={urlencoded_sl_name_of_ratee}
slrru={sl_uuid_of_rater}
rt={integer_rating_value}
g={urlencoded_gab_text} or {unique_gab_id}
&k={wkey}
Response: of type - text/plain
rt={success/error}
k={hmac}
HMAC is calculated as following:
  1. remove all carriage return and line feed characters from the output
  2. concatenate the above string with a predefined separator and client key
  3. use MD5 to hash the concatenated string to obtain the hmac.
Example, if the output is:
rt=success
After removing all carriage return and line feed, it becomes
rt=success
then, hash this string and separator (currently is “:ratepoint:”) and client's key together.
The hash result becomes binary HMAC. The binary need to be base64 encoded into a
printable string.
```

TABLE 5
Gab_Submit
URL: http://slwww.ratepoint.com/sl/sl_submit?
METHOD: POST

```
Message:
c=sl
t=gs
slreu={sl_uuid_of_ratee}
slren={urlencoded_sl_name_of_ratee}
slrru={sl_uuid_of_rater}
g={urlencoded_gab_text} or {unique_gab_id}
k={wkey}
Response: of type - text/plain
g={success/error}
k={hmac}
HAMC is calculated as following:
  1. remove all carriage return and line feed characters from the output
  2. concatenate the above string with a predefined separator and client key
  3. use MD5 to hash the concatenated string to obtain the hmac.
Example, if the output is:
g=success
After removing all carriage return and line feed, it becomes
g=success
then, hash this string and separator (currently is “:ratepoint:”) and client's key together.
The hash result becomes binary HMAC. The binary need to be base64 encoded into a
printable string.
```

TABLE 6
Gab_Submit
URL: http//slapi.ratepoint.com/rating/sluser_check?
METHOD: POST

```
Message:
c=sl
t=uc
slrru={sl_uuid_of_rater}
k={wkey}
Response: of type - text/plain
uc={y/n/error}
k={hmac}
HAMC is calculated as following:
  4. remove all carriage return and line feed characters from the output
  5. concatenate the above string with a predefined separator and client key
  6. use MD5 to hash the concatenated string to obtain the hmac.
Example, if the output is:
uc=y
After removing all carriage return and line feed, it becomes
uc=y
then, hash this string and separator (currently is “:ratepoint:”) and client's key together.
The hash result becomes binary HMAC. The binary need to be base64 encoded into a
printable string.
```

API communications may be performed in a secure fashion (i.e. via SSL) or a non-secure fashion. In certain embodiments, communications are http to accommodate communication load. In other embodiments communications could be performed securely and used to work within the Second Life environment. In preferred embodiments, selected items could be communicated securely (i.e. via SSL) including keys or other identifiers for additional layers of security, while other communications are non-secure. In present embodiments, a basic HMAC feature is provided for a basic level of security within the environment. This particular function will help reduce fraud related activity to and from the RatePoint Second Life API environment.

In preferred embodiments, communications and exchanges between the rating service 111 and the Second Life environment is performed via standard HTTP request and response methods. Examples of the available communication methods are located at the following location: http://wiki.secondlife.com/wiki/Main_Page and http://wiki.secondlife.com/wiki/L1HTTPRequest, as well as other developer documentation resources well-known in the art. The HUDs, utilities and scripts created to interact with the rating service 111 are done using LSL (Linden Scripting Language) which can be found at the following location: http://wiki.secondlife.com/wiki/LSL_Portal.

One of the key aspects which will allow all users of the SecondLife environment to interact with and make use of the rating service 111 is the ability of the user to gain access without downloading new client applications. Upon registering for the RatePoint services, the user receives the Ratepack scripts. The user simply installs and enables the RatePoint Ratepack scripts and services without the need to install a modified version of the SecondLife client application. The scripts technology utilized by the RatePack is well known in the art.

### Alternate Embodiments

Although the above description refers to preferred embodiments of a system and method for providing a cross platform and cross ecosystem rating service, other embodiments may also be used. As is illustrated in FIG. 1, embodiments in which a website 108 is in direct communication with the server side web service 112 are also included. For example, ratings created by the target websites 108 themselves may be incorporated into the web service rating system independently of the participant 102 accessing the website 108. Additionally, in preferred embodiments websites and networked pages, and any content contained by and identifiable within, said websites and pages may be rated. Which content may be rated depends upon the specific characteristics of the application used to create website or networked page itself.

Preferred embodiments of the invention utilizes a range of computer and computer system technologies widely known in the art, including memory storage technologies, central processing units, input/output methods, bus control circuitry and other portions of computer architecture. Additionally, a broad range of internet technologies well-known in the art are used.

As described above, certain embodiments allow individuals and/or entities to provide, receive, and utilize rating information about a particular URI, application, element and/or object within or accessible via a URI and/or application in a portable fashion across multiple platforms and eco-systems.

The common use of preferred embodiments of the invention will be in electronic transactions when users of the service would like to utilize and/or participate in rating information, which may help facilitate an interaction or usage decision in ecommerce and other electronic transactions. Preferred embodiments of the invention also allow users of the service to participate and utilize rating information for traditional brick and mortar businesses and services. Rating information is made available in a portable fashion, delivering the appropriate rating and additional materials across multiple platforms and eco-systems.

Other concepts of utilizing the information is to provide a “rate it forward” model which allows a participant 102 the ability to participate in a rating, while also putting it forward to any person. The way this would work is when a participant 102 selects a “rate it forward” option, the standard rating dialogs would be in affect, and in addition, the participant 102 would have the ability to forward the action to anyone the participant 102 chooses. This would trigger the standard rating event to be recorded in the service 111 environment, and also inform the “rate it forward” recipient, via email or another electronic means that a particular participant has asked that this person be notified, and made aware of this site, page, content or whatever the rating is attached too. In addition the person receiving the “rate it forward” would also be able to see a custom message and the rating details provided by the participant.

An area for search overlay and interaction with major, known, independent, and new emerging search services presents a new opportunity to provide an extended version of the service 111 for search called “Rated Search”. Specifically, by leveraging the rating information from the service 111 and the social rating information and circles of the participants 102 within the service 111 certain embodiments can leverage the standard search engines and reformat all results in a new fresh socialized way specific to each participant 102 or user. So, in this case the participant 102 or user would be using service toolbar 104, through a web site sponsored and operated by the service 111, or through a service or web site 108 such as another search engine that has directly integrated with the service 111. This would have the ability to sort, and reorder based on social characteristics of the participant 102 or user. Query information responses as they stand today are based on an anonymous user performing lookups, and the results are ordered mostly based on the popularity of web sites 108 and pages as others link to them. The more links in to a web site 108 traditionally makes them appear first on the returning search results, or, if the web site 108 is paying for sponsored advertising etc. With “Rated Search” the search results appear solely based on the participants 102 likes and dislikes as a result of participation in the service 111. If performing search queries and doing this through the service toolbar 104, through a web site sponsored and operated by the service 111, or through a service or web site 108 such as another search engine that has directly integrated with the service 111 the results returned will be displayed based on the participant 102 specific ratings who is performing the search, as well as ratings calculated based on the participants 102 social circle calculations within the service 111 and its sub service applications, such as the API service 110 and Web service 112. In addition, the search results can be displayed in a number of sorted fashions, such as most recent, most relevant, most rated, highest rated, lowest rated etc.

As described above, preferred embodiments provide a rating capability that is non-intrusive and non-disruptive to users. It allows users to submit rating information and to receive an aggregate form of rating. In certain embodiments the aggregate form may be an arithmetic mean rating for all users, or some form of mean rating from a specified set of users, such as automatically generated set of users such as a social network with similar internet activities or the like. Obviously others forms of statistical measures and ratings may be used as well. Different forms of ratings may be provided to different users. For example, registered users may get one form of rating information provided to them and unregistered users may get another. In preferred embodiments, the rating service not only provides aggregate ratings but also provides the user with raw rating values including, for example the rating the user him/herself submitted.

Inventors envision the use of the rating service with a variety of multiplayer gaming environments including networked Metaverse gaming environments, massive multi-player online games (MMOG) and online virtual world games including but not limited to Second Life and World of Warcraft.

It will be further appreciated that the scope of the present invention is not limited to the above-described embodiments but rather is defined by the appended claims, and that these claims will encompass modifications and improvements to what has been described.

What is claimed is:

1. A method of providing a computerized rating service, that method comprising:
identifying a plurality of users of the computerized rating service, wherein each of said plurality of users interacts with a computerized entity via a user display and computerized user controls associated with that display;
identifying a plurality of ratable, identifiable computerized entities, wherein each of said plurality of ratable identifiable computerized entities is accessible to at least one of said plurality of users by way of said user display and computerized user controls;
providing computerized rating controls to be co-presented on the user display with the ratable, identifiable computerized entity, said rating controls allowing each user to submit computerized rating information about the ratable entity substantially allowing said user continuous, uninterrupted observation of and interaction with said ratable, identifiable computerized entity;
providing computerized rating information to be co-presented on the user display with the ratable, identifiable computerized entity, said computerized rating information including an aggregate rating that is a function of a set of users of the computerized rating service;
wherein said rating information is collected by a service that is separate from the ratable, identifiable computerized entities and wherein said collected information is processed to create the aggregate rating by a service that is separate from the ratable computerized entities.

2. The method of claim 1 wherein different aggregate ratings are provided depending on whether a user is a registered user of the service or an unregistered user of the service.

3. The method of claim 1 wherein the aggregate rating is a mean rating from a set of users of the service.

4. The method of claim 1 wherein the aggregate rating is a mean rating from a defined set of users associated with a given user by similar activity among users in the set.

5. The method of claim 1 wherein the ratable, identifiable computerized entities are identified by at least one of a unique user identification (UUID), Asset ID and Object ID.

6. The method of claim 1 wherein the ratable, identifiable computerized entities are identified by an identification including assets, agents and simulators.

7. The method of claim 1 further including providing the computerized rating information to the computerized rating controls to be co-presented on the user display with the rating controls.

8. The method of claim 7 wherein the computerized rating controls includes a private panel available to a registered user including controls to submit rating information and areas for displaying rating information.

9. The method of claim 1 wherein the computerized rating controls include an overlay to be co-presented on a browser for co-presenting the ratable service, said overlay including controls to submit rating information and areas for displaying rating information

10. The method of claim 1 wherein the plurality of ratable identifiable computerized entities are entities of the gaming environment further comprising a multiplayer gaming environment and wherein the plurality of users of the computerized rating service are users of the gaming environment.

11. The method of claim 10 wherein the computerized rating information is selectively displayed in accordance with the user's proximity within the gaming environment to a ratable identifiable computerized entity.

12. The method of claim 10 wherein the rating control includes an overlay to be co-presented on a gaming environment display, said overlay including controls to submit rating information and areas for displaying rating information.

13. The method of claim 10 wherein the computerized rating information is co-presented in fixed space relation, as determined within the gaming environment, to the ratable identifiable computerized entity.

14. The method of claim 10 the ratable identifiable computerized entity includes registered and unregistered users of the service.

15. The method of claim 1 wherein rating information collected by a service that is separate from the ratable computerized entity includes rating information on a plurality of ratable identifiable computerized entities that are entities of a gaming environment and rating information on a plurality of ratable identifiable computerized entities that are not entities of the gaming environment.
